(19) United States
(12) Patent Application Publication
(10) Pub. No.: US 2011/0273449 A1
(43) Pub. Date: Nov. 10, 2011

(54) VIDEO PROCESSING APPARATUS AND VIDEO DISPLAY APPARATUS

(76) Inventors: Shinya Kiuchi, Osaka (JP); Mitsuhiro Mori, Osaka (JP)

(21) Appl. No.: 13/140,902

(22) PCT Filed: Dec. 17, 2009
(86) PCT No.: PCT/JP2009/006986

§ 371 Date: Jun. 20, 2011

(30) Foreign Application Priority Data
Dec. 26, 2008 (JP) 2008-334182

(51) Int. Cl. G06T 15/00; G09G 5/02

(52) U.S. Cl. 345/426; 345/589

(57) ABSTRACT

The present invention provides a video processing apparatus and video display apparatus that are capable of reliably preventing the occurrence of motion blur or dynamic false contours. The video processing apparatus has: a subfield conversion unit (2) for converting an input image into light emission data for each of subfields; a motion vector detection unit (3) for detecting a motion vector using at least two or more input images that are temporally adjacent to each other; a first subfield regeneration unit (4) for collecting light emission data of the subfields of pixels that are located spatially forward by the number of pixels corresponding to the motion vector, and thereby spatially rearranging the light emission data for each of the subfields, in order to generate rearranged light emission data for each of the subfields; and an adjacent region detection unit (41) for detecting an adjacent region between a first image and a second image of the input image, wherein the first subfield regeneration unit (4) does not collect the light emission data outside the adjacent region.

### TECHNICAL FIELD

The present invention relates to a video processing apparatus which processes an input image so as to divide one field or one frame into a plurality of subfields and combine an emission subfield in which light is emitted and a non-emission subfield in which light is not emitted in order to perform gradation display, and to a video display apparatus using this apparatus.

### BACKGROUND ART

A plasma display device has advantages in its thinness and widescreen. In an AC plasma display panel used in such plasma display device, a front panel, which is a glass substrate formed by laying out a plurality of scan electrodes and sustain electrodes, and a rear panel having an array of a plurality of data electrodes, are combined in a manner that the scan electrodes and the sustain electrodes are disposed perpendicular to the data electrodes, so as to form discharge cells arranged in a matrix fashion. Any of the discharge cells is selected and caused to perform plasma emission, in order to display an image on the AC plasma display panel.

When displaying an image in the manner described above, one field is divided in a time direction into a plurality of screens having different luminance weights (these screens are called “subfields” (SF) hereinafter). Light emission or light non-emission by the discharge cells of each of the subfields is controlled, so as to display an image corresponding to one field, or one frame image.

A video display apparatus that performs the subfield division described above has a problem where tone disturbance called “dynamic false contours” or motion blur occurs, deteriorating the display quality of the video display apparatus. In order to reduce the occurrence of the dynamic false contours, Patent Literature 1, for example, discloses an image display device that detects a motion vector in which a pixel of one of a plurality of fields included in a moving image is an initial point and a pixel of another field is a terminal point, converts the moving image into light emission data of the subfields, and reconstitutes the light emission data of the subfields by processing the converted light emission data using the motion vector.

This conventional image display device selects, from among motion vectors, a motion vector in which a reconstitution object pixel of the other field is the terminal point, calculates a position vector by multiplying the selected motion vector by a predetermined function, and reconstitutes the light emission datum of a subfield corresponding to the reconstitution object pixel, by using the light emission datum of the subfield corresponding to the pixel indicated by the position vector. In this manner, this conventional image display device prevents the occurrence of motion blur or dynamic false contours.

As described above, the conventional image display device converts the moving image into the light emission datum of each subfield, to rearrange the light emission data of the subfields in accordance with the motion vectors. A method of rearranging the light emission data of each subfield is specifically described hereinbelow.

FIG. 21 is a schematic diagram showing an example of a transition state on a display screen. FIG. 22 is a schematic diagram for illustrating light emission data of the subfields, which are obtained before rearranging the light emission data of the subfields when displaying the display screen shown in FIG. 21. FIG. 23 is a schematic diagram for illustrating the light emission data of the subfields, which are obtained after rearranging the light emission data of the subfields when displaying the display screen shown in FIG. 21.

FIG. 21 shows an example in which an N−2 frame image D1, N−1 frame image D2, and N frame image D3 are displayed sequentially as continuous frame images, wherein the background of each of these frame images is entirely black (the luminance level thereof is 0, for example), and a white moving object OJ (the luminance level thereof is 255, for example) moving from the left to the right on the display screen is displayed as a foreground.

First of all, the conventional image display device described above converts the moving image into the light emission data of the subfields, and, as shown in FIG. 22, the light emission data of the subfields of the pixels are created for each frame, as follows.

When displaying the N−2 frame image D1, suppose that one field is constituted by five subfields SF1 to SF5. In this case, first, in the N−2 frame the light emission data of all subfields SF1 to SF5 of a pixel P-10 corresponding to the moving object OJ are in a light emission state (the subfields with hatched lines in the diagram), and the light emission data of the subfields SF1 to SF5 of the other pixels are in a light non-emission state (not shown). Next, when the moving object OJ moves horizontally by five pixels in the N−1 frame, the light emission data of all of the subfields SF1 to SF5 of a pixel P-5 corresponding to the moving object OJ are in the light emission state, and the light emission data of the subfields SF1 to SF5 of the other pixels are in the light non-emission state. Subsequently, when the moving object OJ further moves horizontally by five pixels in the N-frame, the light emission data of all of the subfields SF1 to SF5 of a pixel P-0 corresponding to the moving object OJ are in the light emission state, and the light emission data of the subfields SF1 to SF5 of the other pixels are in the light non-emission state.

The conventional image display device described above then rearranges the light emission data of the subfields in accordance with the motion vector, and, as shown in FIG. 23, the light emission data that are obtained after rearranging the subfields of the pixels are created for each frame, as follows.

First, when a horizontal distance equivalent to five pixels is detected as a motion vector V1 from the N−2 frame and the N−1 frame, in the N−1 frame the light emission datum of the first subfield SF1 of the pixel P-5 (in the light emission state) is moved to the left by four pixels. The light emission datum of the first subfield SF1 of a pixel P-9 enters the light emission state from the light non-emission state (the subfield with hatched lines in the diagram). The light emission datum of the first subfield SF1 of the pixel P-5 enters the light non-emission state from the light emission state (the white subfield surrounded by a dashed line in the diagram).

The light emission datum of the second subfield SF2 of the pixel P-5 (in the light emission state) is moved to the left by three pixels. The light emission datum of the second subfield SF2 of a pixel P-8 enters the light emission state from the light non-emission state, and the light emission datum of the second subfield SF2 of the pixel P-5 enters the light non-emission state from the light emission state.

The light emission datum of the third subfield SF3 of the pixel P-5 (in the light emission state) is moved to the left by two pixels. The light emission datum of the third subfield SF3 of a pixel P-7 enters the light emission state from the light non-emission state, and the light emission datum of the third subfield SF3 of the pixel P-5 enters the light non-emission state from the light emission state.

The light emission datum of the fourth subfield SF4 of the pixel P-5 (in the light emission state) is moved to the left by one pixel. The light emission datum of the fourth subfield SF4 of a pixel P-6 enters the light emission state from the light non-emission state, and the light emission datum of the fourth subfield SF4 of the pixel P-5 enters the light non-emission state from the light emission state. Moreover, the state of the light emission datum of the fifth subfield SF5 of the pixel P-5 is not changed.

Similarly, when a horizontal distance equivalent to five pixels is detected as a motion vector V2 from the N−1 frame and the N frame, the light emission data of the first to fourth subfields SF1 to SF4 of the pixel P-0 (in the light emission state) are moved to the left by four to one pixels. The light emission datum of the first subfield SF1 of the pixel P-4 enters the light emission state from the light non-emission state, and the light emission datum of the second subfield SF2 of a pixel P-3 enters the light emission state from the light non-emission state. The light emission datum of the third subfield SF3 of the pixel P-2 enters the light emission state from the light non-emission state. The light emission datum of the fourth subfield SF4 of the pixel P-1 enters the light emission state from the light non-emission state. The light emission data of the first to fourth subfields SF1 to SF4 of the pixel P-0 enter the light non-emission state from the light emission state. The state of the light emission datum of the fifth subfield SF5 is not changed.

As a result of this subfield rearrangement process, the line of sight of a viewer moves smoothly along the direction of the arrow AR when the viewer sees the displayed image transiting from the N−2 frame to the N-frame. This can prevent the occurrence of motion blur and dynamic false contours.

However, when a position in which each subfield emits light is corrected by the conventional subfield rearrangement process, the subfields of the pixels that are spatially located forward are distributed to the pixels located therebehind based on the motion vectors. Therefore, the subfields are distributed from the pixels that are not supposed to be distributed. Such problems regarding the conventional subfield rearrangement process are specifically described below.

FIG. 24 is a diagram showing an example of a display screen that displays how a background image passes behind a foreground image. FIG. 25 is a schematic diagram showing an example of light emission data of subfields that are obtained before rearranging the light emission data of the subfields, the light emission data corresponding to a boundary part between the foreground image and the background image that are shown in FIG. 24. FIG. 26 is a schematic diagram showing an example of the light emission data of the subfields that are obtained after rearranging the light emission data of the subfields. FIG. 27 is a diagram showing the boundary part between the foreground image and the background image on the display screen shown in FIG. 24, the boundary part being obtained after rearranging the light emission data of the subfields.

In a display screen D4 shown in FIG. 24, a car C1, which is the background image, passes behind a tree T1, which is the foreground image. The tree T1 stands still, whereas the car C1 moves to the right. At this moment, a boundary part K1 between the foreground image and the background image is shown in FIG. 25. In FIG. 25, pixels P-0 to P-8 constitute the tree T1, and pixels P-9 to P-17 the car C1. Note in FIG. 25 that the subfields belonging to the same pixels are illustrated by hatching. The car C1 in the N frame moves by six pixels from the N−1 frame. Therefore, the light emission data corresponding to the pixel P-15 of the N−1 frame move to the pixel P-9 of the N frame.

The conventional image display device rearranges the light emission data of the subfields in accordance with the motion vectors, and, as shown in FIG. 26, creates the light emission data after rearranging the subfields of the pixels of the N frame as follows.

Specifically, the light emission data of the first to fifth subfields SF1 to SF5 corresponding to the pixels P-8 to P-4 are moved to the left by five to one pixels, and the light emission data of a sixth subfield SF6 corresponding to the pixels P-8 to P-4 are not changed.

As a result of the subfield rearrangement process described above, the light emission data of the first to fifth subfields SF1 to SF5 of the pixel P-9, the light emission data of the first to fourth subfields SF1 to SF4 of the pixel P-10, the light emission data of the first to third subfields SF1 to SF3 of the pixel P-11, the light emission data of the first and second subfields SF1 and SF2 of the pixel P-12, and the light emission datum of the first subfield SF1 of the pixel P-13, become the light emission data of the subfields that correspond to the pixels constituting the tree T1.

More specifically, the light emission data of the subfields within a triangle region R1, corresponding to the tree T1, are rearranged, as shown in FIG. 26. Because the pixels P-9 to P-13 originally belong to the car C1, rearranging the light emission data of the first to fifth subfields SF1 to SF5 of the pixels P-8 to P-4 belonging to the tree T1 causes motion blur or dynamic false contours at the boundary part between the car C1 and the tree T1, deteriorating the image quality as shown in FIG. 27.

Moreover, using the conventional subfield rearrangement process to correct the light emission position of each subfield in the region where the foreground image and the background image overlap makes it difficult to determine whether the light emission data of the subfields constituting the foreground image should be arranged or the light emission data of the subfields constituting the background image should be arranged. The problems of the conventional subfield rearrangement process are specifically described next.

FIG. 28 is a diagram showing an example of a display screen that displays how the foreground image passes in front of the background image. FIG. 29 is a schematic diagram showing an example of the light emission data of the subfields that are obtained before rearranging the light emission data of the subfields in an overlapping part where the foreground image and background image shown in FIG. 28 overlap on each other. FIG. 30 is a schematic diagram showing an example of the light emission data of the subfields that are obtained after rearranging the light emission data of the subfields. FIG. 31 is a diagram showing the overlapping part where the foreground image and the background image overlap on each other on the display screen shown in FIG. 28, the overlapping part being obtained after rearranging the light emission data of the subfields.

In a display screen D5 shown in FIG. 28, a ball B1, which is a foreground image, passes in front of a tree T2, which is a background image. The tree T2 stands still, whereas the ball B1 moves to the right. At this moment, an overlapping part where the foreground image and the background image overlap on each other is shown in FIG. 29. In FIG. 29, the ball B1 in an N frame moves by seven pixels from an N−1 frame. Therefore, the light emission data corresponding to pixels P-14 to P-16 of the N−1 frame move to pixels P-7 to P-9 of the N frame. Note in FIG. 29 that the subfields belonging to the same pixels are illustrated by the same hatching.

Here, the conventional image display device rearranges the light emission data of the subfields in accordance with the motion vectors, so as to create the light emission data, as follows, after rearranging the subfields of the pixels in the N frame as shown in FIG. 30.

Specifically, the light emission data of the first to fifth subfields SF1 to SF5 of the pixels P-7 to P-9 are moved to the left by five to one pixels, but the light emission data of the sixth subfield SF6 corresponding to the pixels P-7 to P-9 are not changed.

Because the values of the motion vectors of the pixels P-7 to P-9 are not 0 at this moment, the light emission data of the sixth subfield SF6 of the pixel P-7, the fifth and sixth subfields SF5 and SF6 of the pixel P-8, and the fourth to sixth subfields SF4 to SF6 of the pixel P-9, are rearranged, the light emission data corresponding to the foreground image. However, since the values of the motion vectors of the pixels P-10 to P-14 are 0, it is unknown whether to rearrange the light emission data corresponding to the background image or the light emission data corresponding to the foreground image, as for the third to fifth subfields SF3 to SF5 of the pixel P-10, the second to fourth subfields SF2 to SF4 of the pixel P-11, the first to third subfields SF1 to SF3 of the pixel P-12, the first and second subfields SF1 and SF2 of the pixel P-13, and the first subfield SF1 of the pixel P-14.

The subfields within a square region R2 shown in FIG. 30 indicate the case where the light emission data corresponding to the background image are rearranged. When the light emission data corresponding to the background image are rearranged in such a manner in the section where the foreground image and the background image overlap on each other, the luminance of the ball B1 decreases as shown in FIG. 30. Consequently, motion blur or dynamic false contours can be generated in the overlapping part between the ball B1 and the tree T2, deteriorating the image quality.

### CITATION LIST

### Patent Literature

Patent Literature 1: Japanese Patent Application Publication No. 2008-209671

### SUMMARY OF INVENTION

An object of the present invention is to provide a video processing apparatus and video display apparatus that are capable of reliably preventing the occurrence of motion blur or dynamic false contours.

A video processing apparatus according to one aspect of the present invention is a video processing apparatus, which processes an input image so as to divide one field or one frame into a plurality of subfields and combine an emission subfield in which light is emitted and a non-emission subfield in which light is not emitted in order to perform gradation display, the video processing apparatus having: a subfield conversion unit for converting the input image into light emission data for each of the subfields; a motion vector detection unit for detecting a motion vector using at least two or more input images that are temporally adjacent to each other; a first regeneration unit for collecting the light emission data of the subfields of pixels that are located spatially forward by the number of pixels corresponding to the motion vector detected by the motion vector detection unit, and thereby spatially rearranging the light emission data for each of the subfields that are converted by the subfield conversion unit, so as to generate rearranged light emission data for each of the subfields; and a detection unit for detecting an adjacent region between a first image and a second image contacting with the first image in the input image, wherein the first regeneration unit does not collect the light emission data outside the adjacent region detected by the boundary detection unit.

According to this video processing apparatus, the input image is converted into the light emission data for each of the subfields, and the motion vector is detected using at least two or more input images that are temporally adjacent to each other. The light emission data for each of the subfields are spatially rearranged by collecting the light emission data of the subfields of the pixels that are located spatially forward by the number of pixels corresponding to the motion vector, whereby the rearranged light emission data for each of the subfields are generated. In so doing, the adjacent region between the first image and the second image contacting with the first image in the input image is detected, and the light emission data are not collected outside this detected adjacent region.

According to the present invention, when collecting the light emission data of the subfields of the pixels that are located spatially forward by the number of pixels corresponding to the motion vector, the light emission data are not collected outside the adjacent region between the first image and the second image contacting with the first image in the input image. Therefore, motion blur or dynamic false contours that can occur in the vicinity of the boundary between the foreground image and the background image can be prevented reliably.

The objects, characteristics and advantages of the present invention will become apparent from the detailed description of the invention presented below in conjunction with the attached drawings.

### BRIEF DESCRIPTION OF DRAWINGS

FIG. 1 is a block diagram showing a configuration of a video display apparatus according to an embodiment of the present invention.

FIG. 2 is a schematic diagram for illustrating a subfield rearrangement process according to the embodiment.

FIG. 3 is a schematic diagram showing how subfields are rearranged when a boundary is not detected.

FIG. 4 is a schematic diagram showing how the subfields are rearranged when a boundary is detected.

FIG. 5 is a schematic diagram showing an example of light emission data of the subfields, which are obtained after rearranging the subfields shown in FIG. 25 in the embodiment.

FIG. 6 is a diagram showing a boundary part between a foreground image and a background image on a display screen shown in FIG. 24, the boundary part being obtained after rearranging the light emission data of the subfields in the embodiment.

FIG. 7 is a schematic diagram showing an example of the light emission data of the subfields, which are obtained after rearranging the subfields shown in FIG. 29 in the embodiment.

FIG. 8 is a diagram showing a boundary part between the foreground image and the background image on the display screen shown in FIG. 28, the boundary part being obtained after rearranging the light emission data of the subfields in the embodiment.

FIG. 9 is a schematic diagram showing an example of the light emission data of the subfields, which are obtained prior to the rearrangement process.

FIG. 10 is a schematic diagram showing an example of the light emission data of the subfields, which are obtained after the rearrangement process in which the light emission data are not collected outside the boundary between the foreground image and the background image.

FIG. 11 is a schematic diagram showing an example of the light emission data of the subfields, which are obtained after the rearrangement process is performed by a second subfield regeneration unit.

FIG. 12 is a diagram showing an example of a display screen, which shows how a background image passes behind a foreground image.

FIG. 13 is a schematic diagram showing an example of the light emission data of the subfields, which are obtained before rearranging the light emission data of the subfields, the light emission data corresponding to the boundary part between the foreground image and the background image that are shown in FIG. 12.

FIG. 14 is a schematic diagram showing an example of the light emission data of the subfields, which are obtained after rearranging the light emission data of the subfields by using a conventional rearrangement method.

FIG. 15 is a schematic diagram showing an example of the light emission data of the subfields, which are obtained after rearranging the light emission data of the subfields by means of a rearrangement method according to the embodiment.

FIG. 16 is a diagram showing an example of a display screen, which shows how a first image and second image that move in opposite directions enter behind each other in the vicinity of the center of a screen.

FIG. 17 is a schematic diagram showing an example of the light emission data of the subfields, which are obtained before rearranging the light emission data of the subfields, the light emission data corresponding to a boundary part between the first image and the second image that are shown in FIG. 16.

FIG. 18 is a schematic diagram showing an example of the light emission data of the subfields, which are obtained after rearranging the light emission data of the subfields using the conventional rearrangement method.

FIG. 19 is a schematic diagram showing an example of the light emission data of the subfields, which are obtained after rearranging the light emission data of the subfields using the rearrangement method according to the embodiment.

FIG. 20 is a block diagram showing a configuration of a video display apparatus according to another embodiment of the present invention.

FIG. 21 is a schematic diagram showing an example of a transition state on a display screen.

FIG. 22 is a schematic diagram for illustrating the light emission data of the subfields, which are obtained before rearranging the light emission data of the subfields when displaying the display screen of FIG. 21.

FIG. 23 is a schematic diagram for illustrating the light emission data of the subfields, which are obtained after rearranging the light emission data of the subfields when displaying the display screen shown in FIG. 21.

FIG. 24 is a diagram showing an example of a display screen that displays how a background image passes behind a foreground image.

FIG. 25 is a schematic diagram showing an example of the light emission data of the subfields, which are obtained before rearranging the light emission data of the subfields, the light emission data corresponding to a boundary part between the foreground image and the background image that are shown in FIG. 24.

FIG. 26 is a schematic diagram showing an example of the light emission data of the subfields, which are obtained after rearranging the light emission data of the subfields.

FIG. 27 is a diagram showing the boundary part between the foreground image and the background image on the display screen shown in FIG. 24, the boundary part being obtained after rearranging the light emission data of the subfields.

FIG. 28 is a diagram showing an example of a display screen that displays how the foreground image passes in front of the background image.

FIG. 29 is a schematic diagram showing an example of the light emission data of the subfields, which are obtained before rearranging the light emission data of the subfields, the light emission data corresponding to an overlapping part where the foreground image and background image shown in FIG. 28 overlap on each other.

FIG. 30 is a schematic diagram showing an example of the light emission data of the subfields, which are obtained after rearranging the light emission data of the subfields.

FIG. 31 is a diagram showing the overlapping part where the foreground image and the background image overlap on each other on the display screen shown in FIG. 28, the overlapping part being obtained after rearranging the light emission data of the subfields.

### DESCRIPTION OF EMBODIMENTS

A video display apparatus according to the present invention is described hereinbelow with reference to the drawings. The following embodiments illustrate the video display apparatus using a plasma display apparatus as its example; however, the video display apparatus to which the present invention is applied is not particularly limited to this example, and the present invention can be applied similarly to any other video display apparatuses in which one field or one frame is divided into a plurality of subfields and hierarchical display is performed.

In addition, in the present specification, a term “subfield” implies “subfield period,” and such an expression as “light emission of a subfield” implies “light emission of a pixel during the subfield period.” Moreover, a period of light emission of a subfield means a duration of light emitted by sustained discharge for allowing a viewer to view an image, and does not imply an initialization period or write period during which the light emission for allowing the viewer to view the image is not performed. A light non-emission period immediately before the subfield means a period during which the light emission for allowing the viewer to view the image is not performed, and includes the initialization period, write period, and duration during which the light emission for allowing the viewer to view the image is not performed.

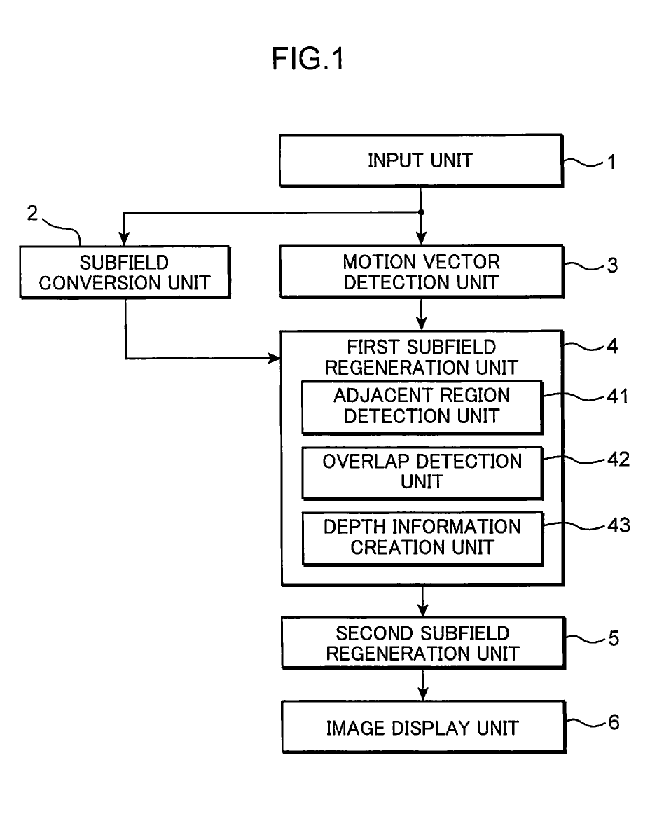

FIG. 1 is a block diagram showing a configuration of the video display apparatus according to an embodiment of the present invention. The video display apparatus shown in FIG. 1 has an input unit 1, a subfield conversion unit 2, a motion vector detection unit 3, a first subfield regeneration unit 4, a second subfield regeneration unit 5, and an image display unit 6. The subfield conversion unit 2, the motion vector detection unit 3, the first subfield regeneration unit 4, and the second subfield regeneration unit 5 constitute a video processing apparatus that processes an input image so as to divide one field or one frame into a plurality of subfields and combine an emission subfield in which light is emitted and a non-emission subfield in which light is not emitted in order to perform gradation display.

The input unit 1 has, for example, a TV broadcast tuner, an image input terminal, a network connecting terminal and the like. Moving image data are input to the input unit 1. The input unit 1 carries out a known conversion process and the like on the input moving image data, and outputs frame image data, obtained after the conversion process, to the subfield conversion unit 2 and the motion vector detection unit 3.

The subfield conversion unit 2 sequentially converts one-frame image data, or image data corresponding to one field, into light emission data of the subfields, and outputs thus obtained data to the first subfield regeneration unit 4.

A gradation expression method of the video display apparatus for expressing gradations level using the subfields is now described. One field is constituted by K subfields. Then, a predetermined weight is applied to each of the subfields in accordance with a luminance of each subfield, and the light emission period is set such that the luminance of each subfield changes in response to the weight. For instance, when a weight of the K^{th} power of 2 is applied using seven subfields, the weights of the first to seventh subfields are, respectively, 1, 2, 4, 8, 16, 32 and 64, thus an image can be expressed within a tonal range of 0 to 127 by combining the subfields in a light emission state or in a light non-emission state. It should be noted that the division number of the subfields and the weighting method are not particularly limited to the examples described above, and various changes can be made thereto.

Two types of frame image data that are temporally adjacent to each other are input to the motion vector detection unit 3. For example, image data of a frame N−1 and image data of a frame N are input to the motion vector detection unit 3. The motion vector detection unit 3 detects a motion vector of each pixel within the frame N by detecting a motion amount between these frames, and outputs the detected motion vector to the first subfield regeneration unit 4. A known motion vector detection method, such as a detection method using a block matching process, is used as the method for detecting the motion vector.

The first subfield regeneration unit 4 collects light emission data of the subfields of the pixels that are spatially located forward by the number of pixels corresponding to the motion vectors detected by the motion vector detection unit 3, so that the temporally precedent subfields move significantly. Accordingly, the first subfield regeneration unit 4 spatially rearranges the light emission data of the subfields, which are converted by the subfield conversion unit 2, with respect to the pixels within the frame N, to generate rearranged light emission data of the subfields for the pixels within the frame N. Note that the first subfield regeneration unit 4 collects the light emission data of the subfields of the pixels that are located two-dimensionally forward in a plane specified by the direction of the motion vectors. In addition, the first subfield regeneration unit 4 includes an adjacent region detection unit 41, an overlap detection unit 42, and a depth information creation unit 43.

The adjacent region detection unit 41 detects an adjacent region between a foreground image and background image of the frame image data that are output from the subfield conversion unit 2, and thereby detects a boundary between the foreground image and the background image. The adjacent region detection unit 41 detects the adjacent region based on a vector value of a target pixel and a vector value of a pixel from which a light emission datum is collected. Note that the adjacent region means a region that includes pixels where a first image and second image are in contact with each other, as well as peripheral pixels thereof. The adjacent region can also be defined as pixels that are spatially adjacent to each other and as a region where the difference between the motion vectors of the adjacent pixels is equal to or greater than a predetermined value.

Although the adjacent region detection unit 41 detects the adjacent region between the foreground image and the background image in the present embodiment, the present invention is not particularly limited to this embodiment. Hence, the adjacent region detection unit 41 may detect an adjacent region between the first image and the second image that is in contact with the first image.

The overlap detection unit 42 detects an overlap between the foreground image and the background image. The depth information creation unit 43 creates, when an overlap is detected by the overlap detection unit 42, depth information for each of the pixels where the foreground image and the background image overlap on each other, the depth information indicating whether each of the pixels corresponds to the foreground image or the background image. The depth information creation unit 43 creates the depth information based on the sizes of motion vectors of at least two or more frames. The depth information creation unit 43 further determines whether or not the foreground image is character information representing a character.

The second subfield regeneration unit 5 changes a light emission datum of a subfield corresponding to a pixel that is moved spatially rearward by the number of pixels corresponding to the motion vector, to a light emission datum of the subfield of the pixel obtained prior to the movement, so that the temporally precedent subfields move significantly, according to the order in which the subfields of the pixels of the frame N are arranged. Note that the second subfield regeneration unit 5 changes the light emission datum of the subfield corresponding to the pixel that is moved two-dimensionally rearward, to the light emission datum of the subfield of the pixel obtained prior to the movement, in a plane specified by the direction of the motion vector.

A subfield rearrangement process performed by the first subfield regeneration unit 4 of the present embodiment is now described. In the present embodiment, the light emission data of the subfields corresponding to the pixels that are spatially located forward of a certain pixel are collected, based on the assumption that a vicinal motion vector does not change.

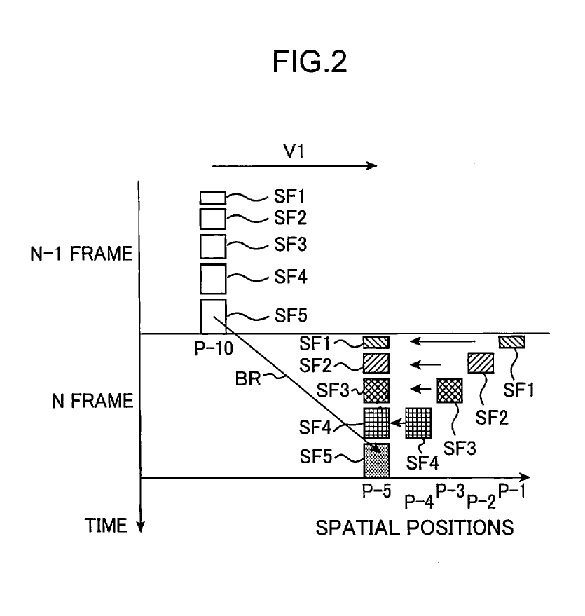

FIG. 2 is a schematic diagram for illustrating the subfield rearrangement process according to the present embodiment. The first subfield regeneration unit 4 rearranges the light emission data of the subfields in accordance with the motion vectors, whereby, as shown in FIG. 2, the rearranged light emission data of the subfields corresponding to the pixels are created, as follows, with respect to each frame.

First of all, when a horizontal distance equivalent to five pixels is detected as a motion vector V1 from an N−1 frame and N frame, in the N frame the light emission datum of a first subfield SF1 of a pixel P-5 is changed to the light emission datum of a first subfield SF1 of a pixel P-1 that is located spatially forward by four pixels (to the right). The light emission datum of a second subfield SF2 of the pixel P-5 is changed to the light emission datum of a second subfield SF2 of a pixel P-2 that is located spatially forward by three pixels (to the right). The light emission datum of a third subfield SF3 of the pixel P-5 is changed to the light emission datum of a third subfield SF3 of a pixel P-3 that is located spatially forward by two pixels (to the right). The light emission datum of a fourth subfield SF4 of the pixel P-5 is changed to the light emission datum of a fourth subfield SF4 of a pixel P-4 that is located spatially forward by one pixel (to the right). The light emission datum of a fifth subfield SF5 of the pixel P-5 is not changed. Note that, in the present embodiment, the light emission data express either a light emission state or a light non-emission state.

As a result of the subfield rearrangement process described above, the line of sight of the viewer moves smoothly along the direction of an arrow BR when the viewer sees a displayed image transiting from the N−1 frame to the N frame, preventing the occurrence of motion blur and dynamic false contours.

As described above, unlike the rearrangement method illustrated in FIG. 23, in the present embodiment the first subfield regeneration unit 4 collects the light emission data of the subfields of the pixels that are located spatially forward by the number of pixels corresponding to the motion vector detected by the motion vector detection unit 3, so that the temporally precedent subfields move significantly. Accordingly, the first subfield regeneration unit 4 spatially rearranges the light emission data of the subfields, which are converted by the subfield conversion unit 2, so as to generate the rearranged light emission data of the subfields.

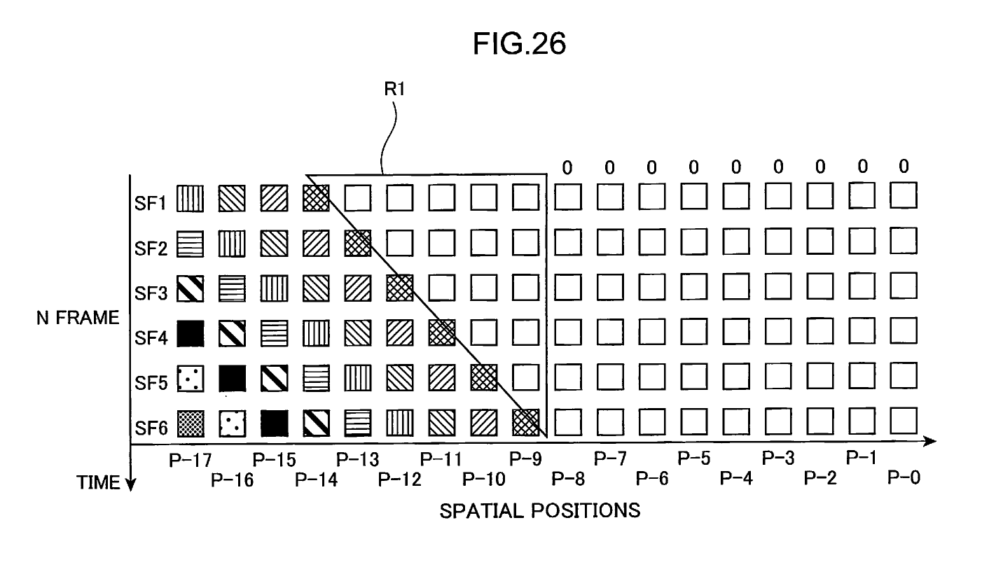

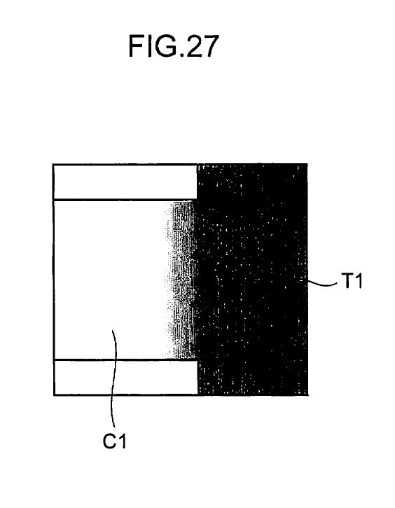

In so doing, with regard to a boundary between the moving background image and the static foreground image, the light emission data of the subfields within the region R1 corresponding to the foreground image are rearranged, as shown in FIG. 26. In this case, the first subfield regeneration unit 4 does not collect the light emission data outside the adjacent region detected by the adjacent region detection unit 41. With regard to the subfields the light emission datum is not collected, the first subfield regeneration unit 4 collects the light emission data of the subfields corresponding to the pixels that are located on the inward side from the adjacent region and within the adjacent region.

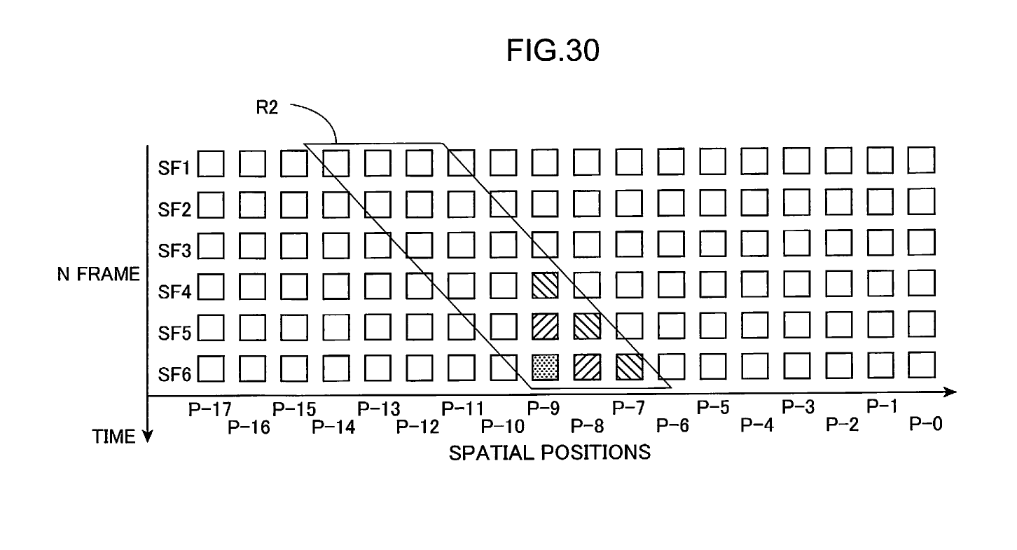

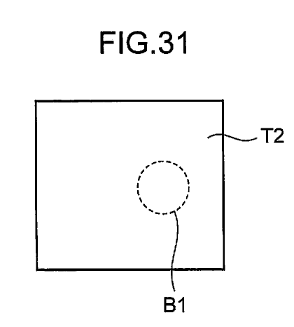

Moreover, with regard to the subfields within the region R2 in an overlapping part where the moving foreground image and the static background image overlap on each other as shown in FIG. 30, when the light emission data of the subfields of the background image are rearranged, not knowing whether the light emission data of the subfields of the foreground image are rearranged or the light emission data of the subfields of the background image are rearranged, the luminance of the foreground image decreases. In this case, when the overlap is detected by the overlap detection unit 42, the first subfield regeneration unit 4 collects the light emission data of the subfields of the pixels constituting the foreground image, based on the depth information created by the depth information creation unit 43.

Note that, when the overlap is detected by the overlap detection unit 42, the first subfield regeneration unit 4 may always collect the light emission data of the subfields of the pixels constituting the foreground image, based on the depth information created by the depth information creation unit 43. In the present embodiment, however, when the overlap is detected by the overlap detection unit 42 and the depth information creation unit 43 determines that the foreground image is not the character information, the first subfield regeneration unit 4 collects the light emission data of the subfields of the pixels constituting the foreground image.

In the case where the foreground image is a character moving on the background image, instead of collecting the light emission data of the subfields of the pixels that are located spatially forward, the light emission data of the subfields corresponding to the pixels that are located spatially rearward are changed to the light emission data of the subfields of the pixels obtained prior to the movement, so that the line of sight of the viewer can be moved more smoothly.

For this reason, in the case where the overlap is detected by the overlap detection unit 42 and the depth information creation unit 43 determines that the foreground image is the character information, the second subfield regeneration unit 5 uses the depth information created by the depth information creation unit 43, to change the light emission data of the subfields corresponding to the pixels that are moved spatially rearward by the number of pixels corresponding to the motion vector, to the light emission data of the subfields of the pixels obtained prior to the movement, so that the temporally precedent subfields move significantly.

The image display unit 6, with a plasma display panel, a panel drive circuit and the like, controls ON/OFF of each subfield of each pixel on the plasma display panel, to display a moving image.

Next is described in detail a light emission data rearrangement process performed by the video display apparatus configured as described above. First, moving image data are input to the input unit 1, in response to which the input unit 1 carries out a predetermined conversion process on the input moving image data, and then outputs frame image data, obtained as a result of the conversion process, to the subfield conversion unit 2 and the motion vector detection unit 3.

Subsequently, the subfield conversion unit 2 sequentially converts the frame image data into the light emission data of the first to sixth subfields SF1 to SF6 with respect to the pixels of the frame image data, and outputs this obtained light emission data to the first subfield regeneration unit 4.

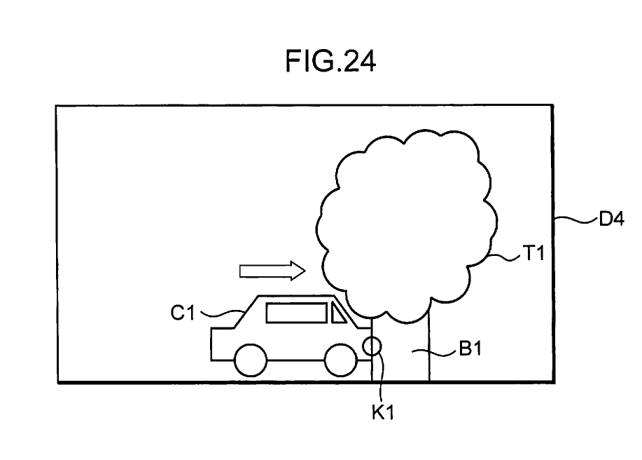

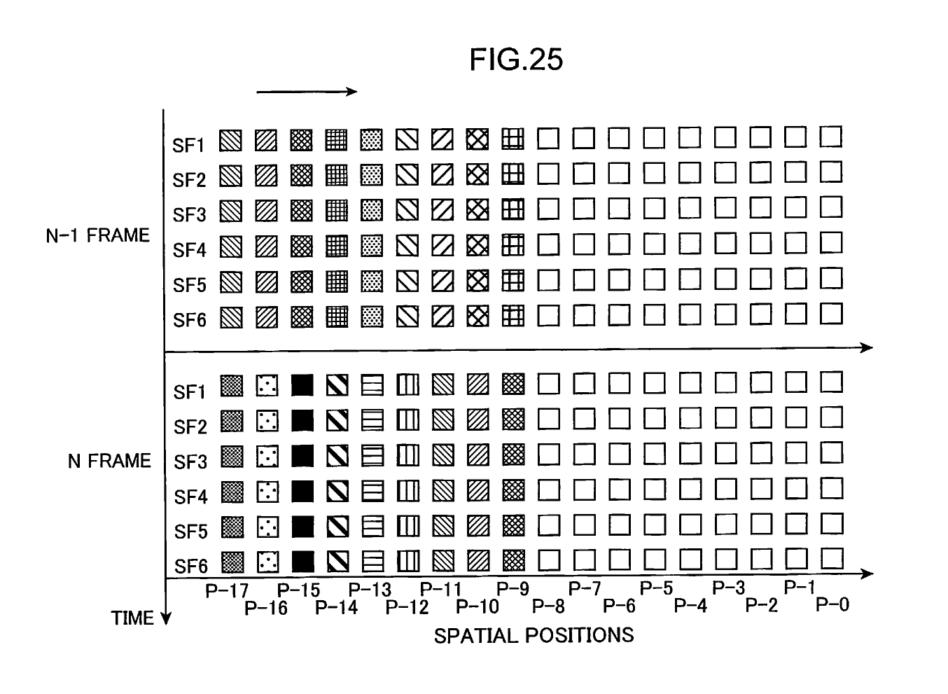

For example, suppose that the input unit 1 receives an input of the moving image data in which a car C1, a background image, passes behind a tree T1, a foreground image, as shown in FIG. 24. In this case, the pixels in the vicinity of a boundary between the tree T1 and the car C1 are converted into the light emission data of the first to sixth subfields SF1 to SF6, as shown in FIG. 25. The subfield conversion unit 2 generates light emission data in which the first to sixth subfields SF1 to SF6 of pixels P-0 to P-8 are set in the light emission state corresponding to the tree T1 and the first to sixth subfields SF1 to SF6 of pixels P-9 to P-17 are set in the light emission state corresponding to the car C1, as shown in FIG. 25. Therefore, when the subfields are not rearranged, an image constituted by the subfields shown in FIG. 25 is displayed on the display screen.

In conjunction with the creation of the light emission data of the first to sixth subfields SF1 to SF6 described above, the motion vector detection unit 3 detects a motion vector of each pixel between two frame image data that are temporally adjacent to each other, and outputs the detected motion vectors to the first subfield regeneration unit 4.

Thereafter, the first subfield regeneration unit 4 collects the light emission data of the subfields of the pixels that are located spatially forward by the number of pixels corresponding to the motion vectors, so that the temporally precedent subfields move significantly, according to the order in which the first to sixth subfields SF1 to SF6 are arranged. Accordingly, the first subfield regeneration unit 4 spatially rearranges the light emission data of the subfields, which are converted by the subfield conversion unit 2, to generate the rearranged light emission data of the subfields.

The adjacent region detection unit 41 detects the boundary (adjacent region) between the foreground image and the background image in the frame image data that are output from the subfield conversion unit 2.

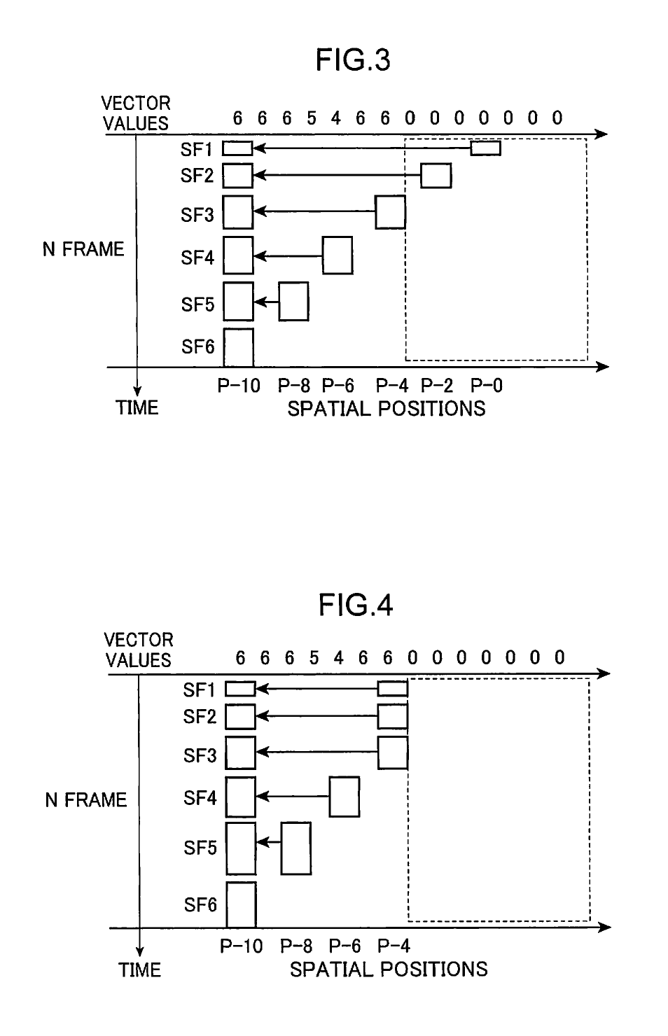

A boundary detection method by the adjacent region detection unit 41 is now described in detail. FIG. 3 is a schematic diagram showing how the subfields are rearranged when the boundary is not detected. FIG. 4 is a schematic diagram showing how the subfields are rearranged when the boundary is detected.

With regard to the subfields corresponding to the target pixel, when the difference between the vector value of the target pixel and the vector value of a pixel, from which a light emission datum is collected, is greater than a predetermined value, the adjacent region detection unit 41 determines that the pixel, from which the light emission datum collected, exists outside the boundary. In other words, when the difference diff between the vector value Val of the target pixel and the vector value of the pixel, from which the light emission datum is collected, satisfies the following formula (1) with regard to each subfield corresponding to the target pixel, the adjacent region detection unit 41 determines that the pixel, from which the light emission datum is collected, exists outside the boundary.

diff>±Val/2 (1)

For instance, in FIG. 3, the light emission datum of the first subfield SF1 of a target pixel P-10 is changed to the light emission datum of the first subfield SF1 of the pixel P-0. Also, the light emission datum of the second subfield SF2 of the target pixel P-10 is changed to the light emission datum of the second subfield SF2 of the pixel P-2. The light emission datum of the third subfield SF3 of the target pixel P-10 is changed to the light emission datum of the third subfield SF3 of the pixel P-4. The light emission datum of the fourth subfield SF4 of the target pixel P-10 is changed to the light emission datum of the fourth subfield SF4 of the pixel P-6. The light emission datum of the fifth subfield SF5 of the target pixel P-10 is changed to the light emission datum of the fifth subfield SF5 of the pixel P-8. The light emission datum of the sixth subfield SF6 of the target pixel P-10 is not changed.

At this moment, the vector values of the pixels P-10 to P-0 are “6,” “6,” “4,” “6,” “0,” and “0” respectively. With regard to the first subfield SF1 of the target pixel P-10, the difference diff between the vector value of the target pixel P-10 and the vector value of the pixel P-0 is “6” and Val/2 is “3.” Therefore, the first subfield SF1 of the target pixel P-10 satisfies the formula (1). In this case, the adjacent region detection unit 41 determines that the pixel P-0 exists outside the boundary, and the first subfield regeneration unit 4 does not change the light emission datum of the first subfield SF1 of the target pixel P-10 to the light emission datum of the first subfield SF1 of the pixel P-0.

Similarly, with regard to the second subfield SF2 of the target pixel P-10, the difference diff between the vector value of the target pixel P-10 and the vector value of the pixel P-2 is “6” and val/2 is “3.” Therefore, the second subfield SF2 of the target pixel P-10 satisfies the formula (1). In this case, the adjacent region detection unit 41 determines that the pixel P-2 is outside the boundary, and the first subfield regeneration unit 4 does not change the light emission datum of the second subfield SF2 of the target pixel P-10 to the light emission datum of the second subfield SF2 of the pixel P-2.

With regard to the third subfield SF3 of the target pixel P-10, on the other hand, the difference diff between the vector value of the target pixel P-10 and the vector value of the pixel P-4 is “0” and Val/2 is “3.” Therefore, the third subfield SF3 of the target pixel P-10 does not satisfy the formula (1). In this case, the adjacent region detection unit 41 determines that the pixel P-4 exists within the boundary, and the first subfield regeneration unit 4 changes the light emission datum of the third subfield SF3 of the target pixel P-10 to the light emission datum of the third subfield SF3 of the pixel P-4.

With regard to the fourth and fifth subfields SF4 and SF5 corresponding to the target pixel P-10 as well, the adjacent region detection unit 41 determines that the pixels P-6 and P-8 exist within the boundary, and the first subfield regeneration unit 4 changes the light emission data of the fourth and fifth subfields SF4 and SF5 of the target pixel P-10 to the light emission data of the fourth and fifth subfields SF4 and SF5 corresponding to the pixels P-6 and P-8.

At this moment, the shift amount of the first subfield SF1 of the target pixel P-10 is equivalent to 10 pixels. The shift amount of the second subfield SF2 of the target pixel P-10 is equivalent to 8 pixels. The shift amount of the third subfield SF3 of the target pixel P-10 is equivalent to 6 pixels. The shift amount of the fourth subfield SF4 of the target pixel P-10 is equivalent to 4 pixels. The shift amount of the fifth subfield SF5 of the target pixel P-10 is equivalent to 2 pixels. The shift amount of the sixth subfield SF6 of the target pixel P-10 is equivalent to 0.

Because the adjacent region detection unit 41 can determine whether each of these pixels exists within the boundary or not, when any of the pixels, from which the light emission datum is collected, is determined to exist outside the boundary, the light emission data of the subfield corresponding to the target pixel are changed to the light emission data of the subfields of the pixel that is located on the inward side from the boundary and proximate to the boundary.

More specifically, as shown in FIG. 4, the first subfield regeneration unit 4 changes the light emission datum of the first subfield SF1 of the target pixel P-10 to the light emission datum of the first subfield SF1 of the pixel P-4 that is located on the inward side from the boundary and proximate to the boundary, and changes the light emission datum of the second subfield SF2 of the target pixel P-10 to the light emission datum of the second subfield SF2 of the pixel P-4 that is located on the inward side from the boundary and proximate to the boundary.

At this moment, the shift amount of the first subfield SF1 of the target pixel P-10 is changed from 10 pixels to 6 pixels, and the shift amount of the second subfield SF2 of the target pixel P-10 is changed from 8 pixels to 6 pixels.

The first subfield regeneration unit 4 collects the light emission data of the subfields on a plurality of straight lines as shown in FIG. 4, instead of collecting the light emission data of the subfields arrayed on one straight line as shown in FIG. 3.

Note that, in the present embodiment, when the difference diff between the vector value Val of the target pixel and the vector values of the pixel, from which the light emission datum is collected, satisfies the formula (1), with regard to each of the subfields corresponding to the target pixel, the adjacent region detection unit 41 determines that the pixel, from which the light emission datum is collected, exists outside the boundary; however, the present invention is not particularly limited to this embodiment.

In other words, when the vector value of the target pixel is small, the different diff might not satisfy the formula (1), whether or not the pixel exists in the boundary. Therefore, with regard to each of the subfields corresponding to the target pixel, when the difference diff between the vector value Val of the target pixel and the vector value of the pixel, from which the light emission datum is collected, satisfies the following formula (2), the adjacent region detection unit 41 may determine that the pixel, from which the light emission datum is collected, exists outside the boundary.

diff>Max(3,Val/2) (2)

As shown in the formula (2) above, when the difference diff between the vector value Val of the target pixel and the vector value of the pixel, from which the light emission datum is collected, is greater than Val/2 or 3, whichever is greater, the adjacent region detection unit 41 determines that the pixel, from which the light emission datum is collected, exists outside the boundary. In the formula (2), the numerical value “3” compared to the difference diff is merely an example and can therefore be “2,” “4,” “5,” or any other numerical values.

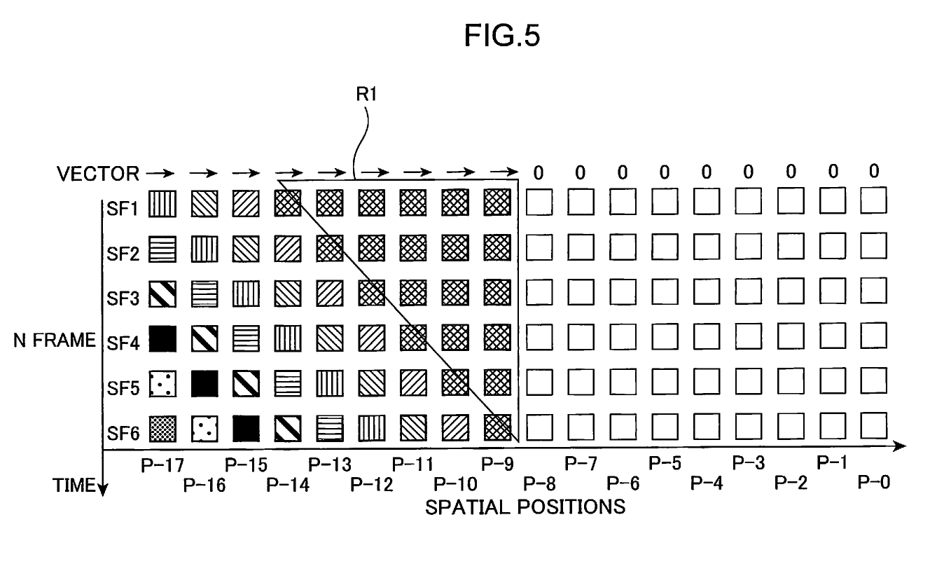

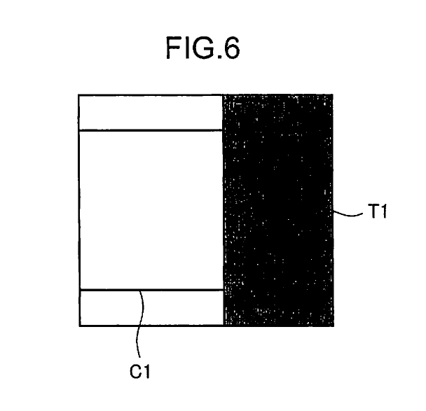

FIG. 5 is a schematic diagram showing an example of the light emission data of the subfields, which are obtained after rearranging the subfields shown in FIG. 25 in the present embodiment. FIG. 6 is a diagram showing a boundary part between the foreground image and the background image on the display screen shown in FIG. 24, the boundary part being obtained after rearranging the light emission data of the subfields in the present embodiment.

Here, the first subfield regeneration unit 4 rearranges the light emission data of the subfields according to the motion vectors, so that the light emission data are created as follows after rearranging the subfields of the pixels within the N frame, as shown in FIG. 5.

Specifically, the light emission data of the first to fifth subfields SF1 to SF5 of the pixel P-17 are changed to the light emission data of the first to fifth subfields SF1 to SF5 of the pixel P-12 to P-16, but the light emission datum of the sixth subfield SF6 of the pixel P-17 is not changed. Note that the light emission data of the subfields corresponding to the pixels P-16 to P-14 are also changed as with the case of the pixel P-17.

Furthermore, the light emission data of the first and second subfields SF1 and SF2 of the pixel P-13 are changed to the light emission data of the first and second subfields SF1 and SF2 of the pixel P-9, and the light emission data of the third to fifth subfields SF3 to SF5 of the pixel P-13 are changed to the light emission data of the third to fifth subfields SF3 to SF5 of the pixels P-10 to P-12, but the light emission datum of the sixth subfield SF6 of the pixel P-13 is not changed.

The light emission data of the first to third subfields SF1 to SF3 of the pixel P-12 are changed to the light emission data of the first to third subfields SF1 to SF3 of the pixel P-9, and the light emission data of the fourth and fifth subfields SF4 and SF5 of the pixel P-12 are changed to the light emission data of the fourth and fifth subfields SF4 and SF5 of the pixels P-10 and P-11, but the light emission datum of the sixth subfield SF6 of the pixel P-12 is not changed.

Moreover, the light emission data of the first to fourth subfields SF1 to SF4 of the pixel P-11 are changed to the light emission of the first to fourth subfields SF1 to SF4 of the pixel P-9, and the light emission datum of the fifth subfield SF5 of the pixel P-11 is changed to the light emission datum of the fifth subfield SF5 of the pixel P-10, but the light emission datum of the sixth subfield SF6 of the pixel P-11 is not changed.

In addition, the light emission data of the first to fifth subfields SF1 to SF5 of the pixel P-10 are changed to the light emission data of the first to fifth subfields SF1 to SF5 of the pixel P-9, but the light emission datum of the sixth subfield SF6 of the pixel P-10 is not changed.

The light emission data of the first to sixth subfields SF1 to SF6 of the pixel P-9 are not changed either.

As a result of the subfield rearrangement process described above, the light emission data of the first to fifth subfields SF1 to SF5 of the pixel P-9, the light emission data of the first to fourth subfields SF1 to SF4 of the pixel P-10, the light emission data of the first to third subfields SF1 to SF3 of the pixel P-11, the light emission data of the first and second subfields SF1 and SF2 of the pixel P-12, and the light emission datum of the first subfield SF1 of the pixel P-13 become the light emission data of the subfields that correspond to the pixel P-9 constituting the car C1.

Thus, the light emission data of the subfields of the pixels that are located spatially forward are arranged in at least some regions between a region to which the rearranged light emission data generated by the first subfield regeneration unit 4 are output and the adjacent region detected by the detection unit 41.

In other words, with regard to the subfields within the triangle region R1 shown in FIG. 5, not the light emission data of the subfields belonging to the tree T1, but the light emission data of the subfields belonging to the car C1 are rearranged. As a result, the boundary between the car C1 and the tree T1 becomes clear, as shown in FIG. 6, preventing the occurrence of motion blur and dynamic false contours, and consequently improving the image quality.

Subsequently, the overlap detection unit 42 detects an overlap between the foreground image and the background image for each subfield. More specifically, upon rearrangement of the subfields, the overlap detection unit 42 counts the number of times the light emission datum of each subfield is written. When the number of times the light emission datum is written is two or more, the relevant subfield is detected as the overlapping part where the foreground image and the background image overlap on each other.

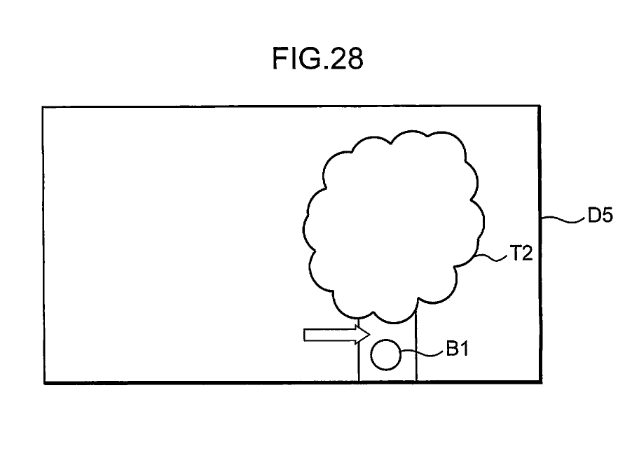

For example, when rearranging the subfields of moving image data in which the foreground image passes on the background image as shown in FIG. 28, two types of light emission data, the light emission data of the background image and the light emission data of the foreground image, are arranged in one subfield of the overlapping part where the background image and the foreground image overlap on each other. Therefore, whether the foreground image and the background image overlap on each other or not can be detected by counting the number of times the light emission datum is written with respect to each subfield.

Next, when the overlap is detected by the overlap detection unit 42, the depth information creation unit 43 computes the depth information for each of the pixels where the foreground image and the background image overlap on each other, the depth information indicating whether each of the pixels corresponds to the foreground image or the background image. More specifically, the depth information creation unit 43 compares the motion vector of the same pixel between two or more frames. When the value of the motion vector changes, the depth information creation unit 43 creates the depth information indicating that the pixel corresponds to the foreground image. When the value of the motion vector does not change, the depth information creation unit 43 creates the depth information indicating that the pixel corresponds to the background image. For example, the depth information creation unit 43 compares the vector value of the same pixel between the N frame and the N−1 frame.

When the overlap is detected by the overlap detection unit 42, the first subfield regeneration unit 4 changes the light emission datum of each of the subfields constituting the overlapping part, to the light emission datum of each of the subfields of the pixels that constitute the foreground image that is specified by the depth information created by the depth information creation unit 43.

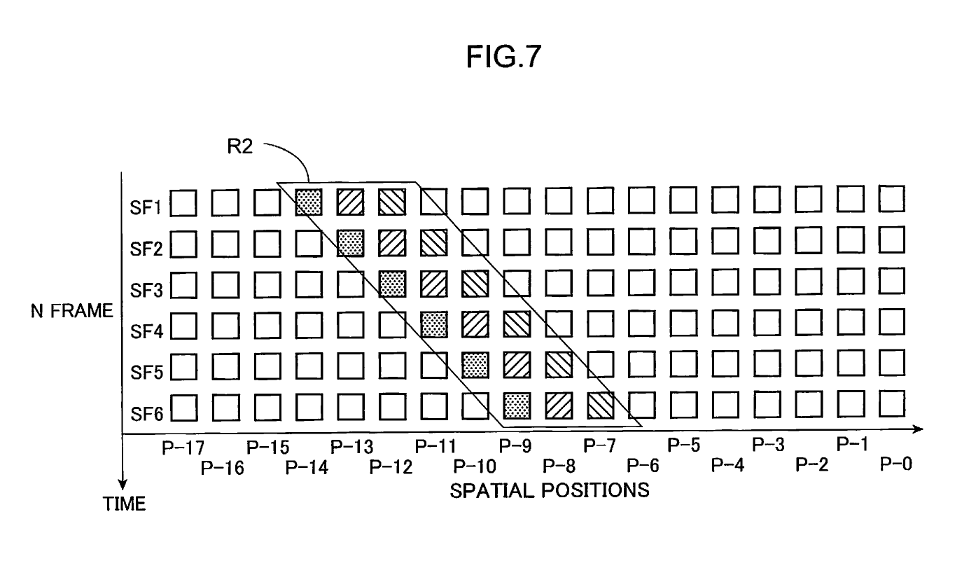

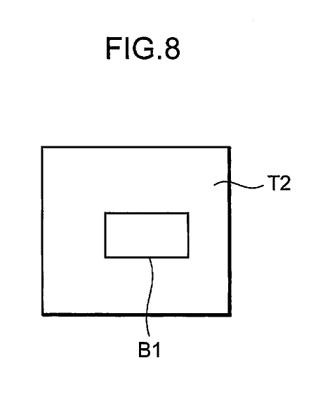

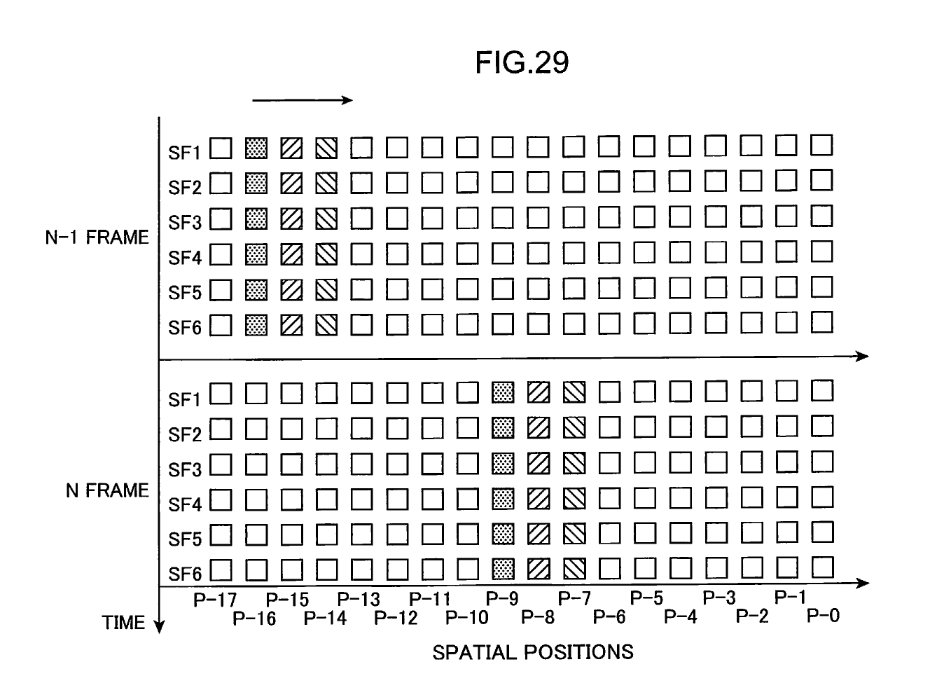

FIG. 7 is a schematic diagram showing an example of the light emission data of the subfields, which are obtained after rearranging the subfields shown in FIG. 29 in the present embodiment. FIG. 8 is a diagram showing a boundary part between the foreground image and the background image on the display screen shown in FIG. 28, the boundary part being obtained after rearranging the light emission data of the subfields in the present embodiment.

Here, the first subfield regeneration unit 4 rearranges the light emission data of the subfields according to the motion vectors, so that the light emission data are created as follows after rearranging the subfields of the pixels within the N frame, as shown in FIG. 7.

First, the first subfield regeneration unit 4 collects the light emission data of the subfields of the pixels that are spatially located forward by the number of pixels corresponding to the motion vector, so that the temporally precedent subfields move significantly, according to the order in which the first to sixth subfields SF1 to SF6 are arranged.

At this moment, the overlap detection unit 42 counts the number of times the light emission datum of each subfield is written. With regard to the first subfield SF1 of the pixel P-14, the first and second subfields SF1 and SF2 of the pixel P-13, the first to third subfields SF1 to SF3 of the pixel P-12, the second to fourth subfields SF2 to SF4 of the pixel P-11, and the third to fifth subfields SF3 to SF5 of the pixel P-10, the light emission data are written twice. Therefore, the overlap detection unit 42 detects these subfields as the overlapping part where the foreground image and the background image overlap on each other.

Subsequently, the depth information creation unit 43 compares the value of the motion vector of the same pixel between the N frame and the N−1 frame prior to the rearrangement of the subfields. When the value of the motion vector changes, the depth information creation unit 43 creates the depth information indicating that the pixel corresponds to the foreground image. When the value of the motion vector does not change, the depth information creation unit 43 creates the depth information indicating that the pixel corresponds to the background image. For instance, in an N frame image shown in FIG. 29, the pixels P-0 to P-6 correspond to the background image, the pixels P-7 to P-9 to the foreground image, and the P-10 to P-17 to the background image.

The first subfield regeneration unit 4 refers to the depth information that is associated with the pixels of the subfields, from which the light emission data of the subfields detected as the overlapping part by the overlap detection unit 42 are collected. When the depth information indicates the foreground image, the first subfield regeneration unit 4 collects the light emission data of the subfields from which the light emission data are collected. When the depth information indicates the background image, the first subfield regeneration unit 4 does not collect the light emission data of the subfields from which the light emission data are collected.

Consequently, as shown in FIG. 7, the light emission datum of the first subfield SF1 of the pixel P-14 is changed to the light emission datum of the first subfield SF1 of the pixel P-9. The light emission data of the first and second subfields SF1 and SF2 of the pixel P-13 are changed to the light emission data of the first subfield SF1 of the pixel P-8 and the second subfield SF2 of the pixel P-9. The light emission data of the first to third subfields SF1 to SF3 of the pixel P-12 are changed to the light emission data of the first subfield SF1 of the pixel P-7, the second subfield SF2 of the pixel P-8, and the third subfield SF3 of the pixel P-9. The light emission data of the second to fourth subfields SF2 to SF4 of the pixel P-11 are changed to the light emission data of the second subfield SF2 of the pixel P-7, the third subfield SF3 of the pixel P-8, and the fourth subfield SF4 of the pixel P-9. The light emission data of the third to fifth subfields SF3 to SF5 of the pixel P-10 are changed to the light emission data of the third subfield SF3 of the pixel P-7, the fourth subfield SF4 of the pixel P-8, and the fifth subfield SF5 of the pixel P-9.

As a result of the subfield rearrangement process described above, the light emission data of the subfields corresponding to the foreground image in the overlapping part between the foreground image and the background image are preferentially collected. In other words, for the subfields within the square region R2 shown in FIG. 7, the light emission data corresponding to the foreground image are rearranged. When the light emission data corresponding to the foreground image in the overlapping part between the foreground image and the background image are rearranged as described above, the luminance of the ball B1 is improved, as shown in FIG. 8, preventing the occurrence of motion blur and dynamic false contours in the overlapping part between the ball B1 and the tree T2, and consequently improving the image quality.

Note, in the present embodiment, that the depth information creation unit 43 creates the depth information for each pixel on the basis of the sizes of the motion vectors of at least two frames, the depth information indicating whether each pixel corresponds to the foreground image or the background image; however, the present invention is not limited to this embodiment. In other words, when the input image that is input to the input unit 1 contains, beforehand, the depth information indicating whether each pixel corresponds to the foreground image or the background image, the depth information creation unit 43 does not need to create the depth information. In this case, the depth information is extracted from the input image that is input to the input unit 1.

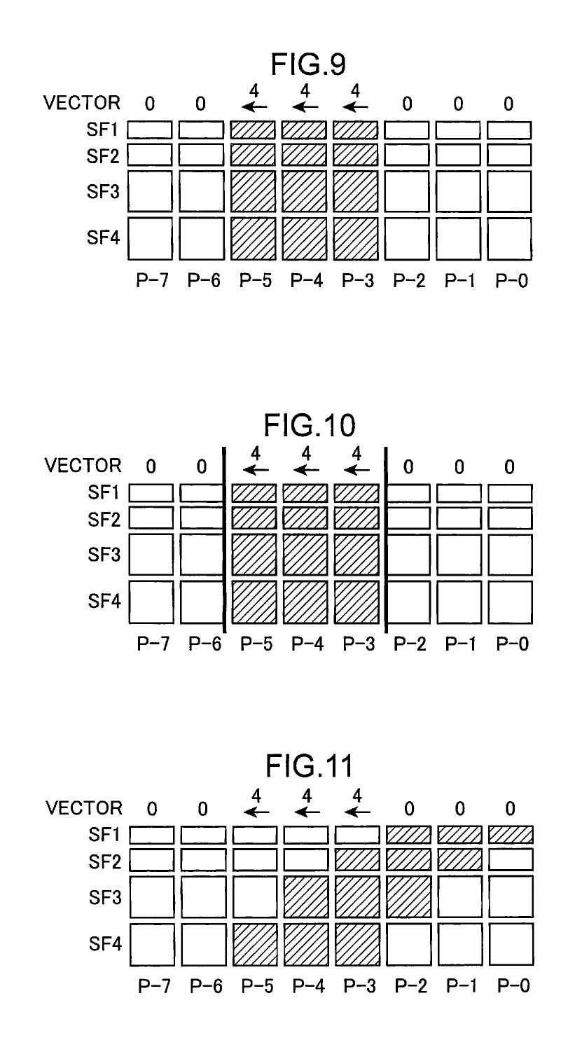

Next is described the subfield rearrangement process performed when the background image is a character. FIG. 9 is a schematic diagram showing an example of the light emission data of the subfields, which are obtained prior to the rearrangement process. FIG. 10 is a schematic diagram showing an example of the light emission data of the subfields, which are obtained after the rearrangement process in which the light emission data are not collected outside the boundary between the foreground image and the background image. FIG. 11 is a schematic diagram showing an example of the light emission data of the subfields, which are obtained after the rearrangement process is performed by the second subfield regeneration unit 5.

In FIG. 9, the pixels P-0 to P-2, P-6 and P-7 are pixels constituting the background image, and the pixels P-3 to P-5 are pixels constituting the foreground image, and a character. The direction of the motion vectors of the pixels P-3 to P-5 is a left direction, and the values of the motion vectors of the pixels P-3 to P-5 are “4.”

Here, when the boundary between the foreground image and the background image is detected and the light emission data are collected within the boundary, the light emission data of the subfields that are obtained after the rearrangement process are rearranged in the pixels P-3 to P-5, as shown in FIG. 10. In this case, the line of sight of the viewer does not move smoothly, and, consequently, motion blur or dynamic false contours might be generated.

In the present embodiment, therefore, when the foreground image represents the character information, the light emission data are allowed to be collected outside the boundary between the foreground image and the background image, and the light emission data of the subfields corresponding to the pixels that are moved spatially rearward by the number of pixels corresponding to the motion vectors are changed to the light emission data of the subfields of the pixels obtained prior to the movement, so that the temporally precedent subfields move significantly.

Specifically, the depth information creation unit 43 recognizes whether the foreground image is a character or not, using known character recognition technology. When the foreground image is recognized as a character, the depth information creation unit 43 adds, to the depth information, information indicating that the foreground image is a character.

When the depth information creation unit 43 identifies the foreground image as a character, the first subfield regeneration unit 4 outputs, to the second subfield regeneration unit 5, the image data that are converted to the plurality of subfields by the subfield conversion unit 2 and the motion vector detected by the motion vector detection unit 3, without performing the rearrangement process.

With regard to the pixels of the character recognized by the depth information creation unit 43, the second subfield regeneration unit 5 changes the light emission data of the subfields corresponding to the pixels that are moved spatially rearward by the number of pixels corresponding to the motion vector, to the light emission data of the subfields of the pixels obtained prior to the movement, so that the temporally precedent subfields move significantly.

As a result, as shown in FIG. 11 the light emission datum of the first subfield SF1 of the pixel P-0 is changed to the light emission datum of the first subfield SF1 of the pixel P-3. The light emission data of the first and second subfields SF1 and SF2 of the pixel P-1 are changed to the light emission data of the first subfield SF1 of the pixel P-4 and the second subfield SF2 of the pixel P-3. The light emission data of the first to third subfields SF1 to SF3 of the pixel P-2 are changed to the light emission data of the first subfield SF1 of the pixel P-5, the second subfield SF2 of the pixel P-4, and the third subfield SF3 of the pixel P-3. The light emission data of the second and third subfields SF2 and SF3 of the pixel P-3 are changed to the light emission data of the second subfield SF2 of the pixel P-5 and the third subfield SF3 of the pixel P-4. The light emission data of the third subfield SF3 of the pixel P-4 is changed to the light emission datum of the third subfield SF3 of the pixel P-5.

As a result of the subfield rearrangement process described above, when the foreground image is a character, the light emission data of the subfields that correspond to the pixels constituting the foreground image are distributed divided up spatially rearward by the number of pixels corresponding to the motion vector so that the temporally precedent subfields move significantly. This allows the line of sight to move smoothly, preventing the occurrence of motion blur or dynamic false contours, and consequently improving the image quality.

With regard to only the pixels that constitute the foreground image moving horizontally in the input image, the second subfield regeneration unit 5 preferably changes the light emission data of the subfields corresponding to the pixels that are moved spatially rearward by the number of pixels corresponding to the motion vector detected by the motion vector detection unit 3, to the light emission data of the subfields of the pixels obtained prior to the movement, so that the temporally precedent subfields move significantly.

In so-called character scroll where a character moves on a screen, the character usually moves in a horizontal direction and not in a vertical direction. Thus, with regard to only the pixels that constitute the foreground image moving horizontally in the input image, the second subfield regeneration unit 5 changes the light emission data of the subfields corresponding to the pixels that are moved spatially rearward by the number of pixels corresponding to the motion vector, to the light emission data of the subfields of the pixels obtained prior to the movement, so that the temporally precedent subfields move significantly. Consequently, the number of vertical line memories can be reduced, and the memories used can be reduced by the second subfield regeneration unit 5.

In the present embodiment, the depth information creation unit 43 recognizes whether the foreground image is a character or not, using the known character recognition technology. When the foreground image is recognized as a character, the depth information creation unit 43 adds, to the depth information, the information indicating that the foreground image is a character. However, the present invention is not particularly limited to this embodiment. In other words, when the input image that is input to the input unit 1 contains, beforehand, the information indicating that the foreground image is a character, the depth information creation unit 43 does not need to recognize whether the foreground image is a character or not.

In this case, the information indicating that the foreground image is a character is extracted from the input image that is input to the input unit 1. Then, the second subfield regeneration unit 5 specifies the pixels constituting the character, based on the information indicating that the foreground image is a character, the information being included in the input image that is input in the input unit 1. Subsequently, for the specified pixels, the second subfield regeneration unit 5 then changes the light emission data of the subfields corresponding to the pixels that are moved spatially rearward by the number of pixels corresponding to the motion vector, to the light emission data of the subfields of the pixels obtained prior to the movement, so that the temporally precedent subfields move significantly.

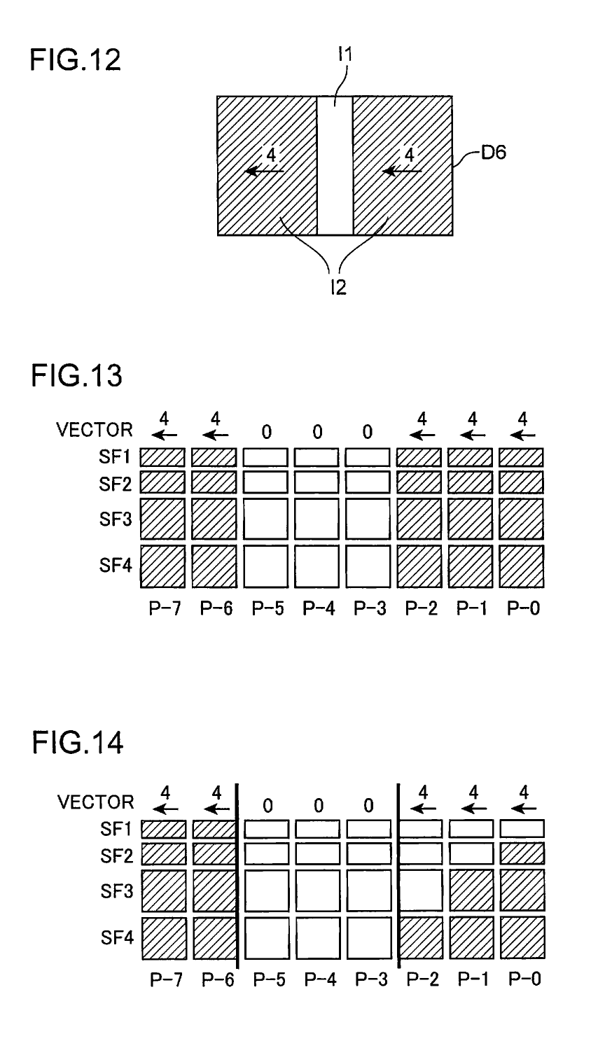

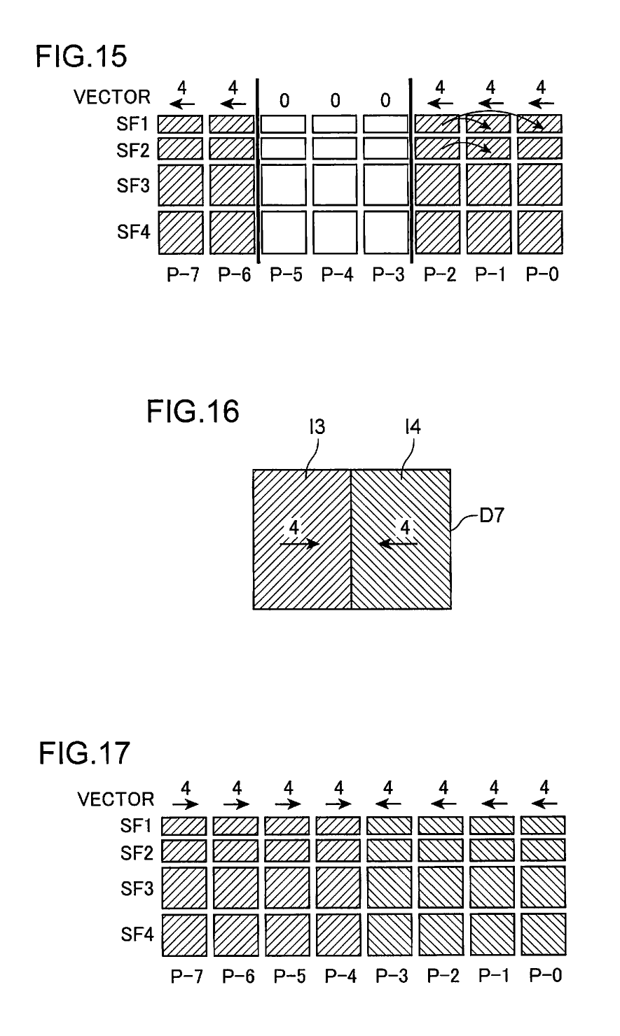

Next is described another example of the subfield rearrangement process for rearranging the subfields in the vicinity of the boundary. FIG. 12 is a diagram showing an example of a display screen, which shows how a background image passes behind a foreground image. FIG. 13 is a schematic diagram showing an example of the light emission data of the subfields, which are obtained before rearranging the light emission data of the subfields, the light emission data corresponding to the boundary part between the foreground image and the background image that are shown in FIG. 12. FIG. 14 is a schematic diagram showing an example of the light emission data of the subfields, which are obtained after rearranging the light emission data of the subfields by using the conventional rearrangement method. FIG. 15 is a schematic diagram showing an example of the light emission data of the subfields, which are obtained after rearranging the light emission data of the subfields by means of the rearrangement method according to the embodiment.

In a display screen D6 shown in FIG. 12, a foreground image I1 disposed in the middle is static, whereas a background image I2 passes behind the foreground image I1 and moves to the left. In FIGS. 12 to 15, the value of the motion vector of each of the pixels constituting the foreground image I1 is “0,” and the value of the motion vector of each of the pixels constituting the background image I2 is “4.”

As shown in FIG. 13, prior to the subfield rearrangement process, the foreground image I1 is constituted by the pixels P-3 to P-5, and the background image I2 is constituted by the pixels P-0 to P-2, P-6, and P-7.

In the case where the light emission data of the subfields shown in FIG. 13 are rearranged using the conventional rearrangement method, the light emission data of the first subfields SF1 corresponding to the pixels P-0 to P-2 are changed to the light emission data of the first subfields SF1 of the pixels P-3 to P-5 as shown in FIG. 14. The light emission data of the second subfields SF2 corresponding to the pixels P-1 and P-2 are changed to the light emission data of the second subfields SF2 corresponding to the pixels P-3 and P-4, and the light emission datum of the third subfield SF3 of the pixel P-2 is changed to the light emission datum of the third subfield SF3 of the pixel P-3.

In this case, because the light emission data of the subfields corresponding to some of the pixels that constitute the foreground image I1 are moved to the background image I2 side, the foreground image I1 sticks out to the background image I2 side at the boundary between the foreground image I1 and the background image I2 on the display screen D6, causing motion blur or dynamic false contours and deteriorating the image quality.

However, when the light emission data of the subfields shown in FIG. 13 are rearranged using the rearrangement method of the present embodiment, the light emission datum of each of the subfields that correspond the pixels P-3 to P-5 constituting the foreground image I1 is not moved, as shown in FIG. 15, but the light emission data of the first subfield SF1 of the pixels P-0 and P-1 are changed to the light emission data of the first subfields SF1 of the pixel P-2, and the light emission datum of the second subfield SF2 of the pixel P-1 is changed to the light emission datum of the second subfield SF2 of the pixel P-2. The light emission data of the first to fourth subfields SF1 to SF4 of the pixel P-2 are not changed.

The present embodiment, as described above, can make the boundary between the foreground image I1 and the background image I2 clear, and reliably prevent the occurrence of motion blur or dynamic false contours, which can be generated when performing the rearrangement process on a boundary part where the motion vectors change significantly.

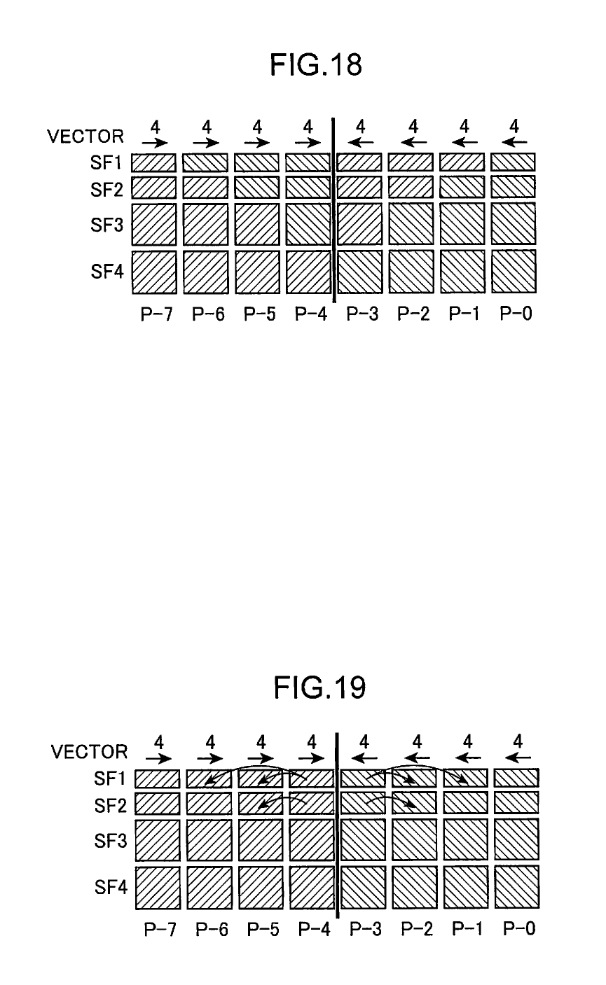

Next is described yet another example of the subfield rearrangement process for rearranging the subfields in the vicinity of a boundary. FIG. 16 is a diagram showing an example of a display screen, which shows how a first image and second image that move in opposite directions enter behind each other in the vicinity of the center of a screen. FIG. 17 is a schematic diagram showing an example of the light emission data of the subfields, which are obtained before rearranging the light emission data of the subfields, the light emission data corresponding to a boundary part between the first image and the second image that are shown in FIG. 16. FIG. 18 is a schematic diagram showing an example of the light emission data of the subfields, which are obtained after rearranging the light emission data of each subfield using the conventional rearrangement method. FIG. 19 is a schematic diagram showing an example of the light emission data of the subfields, which are obtained after rearranging the light emission data of the subfields using the rearrangement method according to the present embodiment.

In a display screen D7 shown in FIG. 16, a first image I3 moving to the right and a second image I4 moving to the left enter behind each other in the vicinity of a center of the screen. Note that, in FIGS. 16 to 19, the value of the motion vector of each of the pixels constituting the first image I3 is “4,” and the value of the motion vector of each of the pixels constituting the second image I4 is also “4.”

As shown in FIG. 17, prior to the subfield rearrangement process, the first image I3 is constituted by pixels P-4 to P-7, and the second image I4 is constituted by pixels P-0 to P-3.

In the case where the light emission data of the subfields shown in FIG. 17 are rearranged using the conventional rearrangement method, the light emission data of the first subfields SF1 corresponding to the pixels P-1 to P-3 are changed to the light emission data of the first subfields SF1 corresponding to the pixels P-4 to P-6, the light emission data of the second subfields SF2 corresponding to the pixels P-2 and P-3 are changed to the light emission data of the second subfields SF2 corresponding to the pixels P-4 and P-5, and the light emission datum of the third subfield SF3 corresponding to the pixel P-3 is changed to the light emission datum of the third subfield SF3 of the pixel P-4, as shown in FIG. 18.

Furthermore, the light emission data of the first subfields SF1 corresponding to the pixels P-4 to P-6 are changed to the light emission data of the first subfields SF1 corresponding to the pixels P-1 to P-3. The light emission data of the second subfields SF2 corresponding to the pixels P-4 and P-6 are changed to the light emission data of the second subfields SF2 corresponding to the pixels P-2 and P-3. The light emission datum of the third subfield SF3 corresponding to the pixel P-4 is changed to the light emission datum of the third subfield SF3 of the pixels P-3.

In this case, because the light emission data of the subfields that correspond to some of the pixels constituting the first image I3 are moved to the second image I4 side, and the light emission data of the subfields that correspond to some of the pixels constituting the second image I4 are moved to the first image I3 side, the first image I3 and the second image I4 stick out of the boundary between the first image I3 and the second image I4 on the display screen D7, causing motion blur or dynamic false contours and consequently deteriorating the image quality.

However, when the light emission data of the subfields shown in FIG. 17 are rearranged using the rearrangement process of the present embodiment, as shown in FIG. 19 the light emission data of the first subfields SF1 corresponding to the pixels P-1 and P-2 are changed to the light emission datum of the first subfield SF1 of the pixel P-3, and the light emission datum of the second subfield SF2 corresponding to the pixel P-2 is changed to the light emission datum of the second subfield SF2 corresponding to the pixel P-3, but the light emission data of the first to fourth subfields SF1 to SF4 corresponding to the pixel P-3 are not changed.

In addition, the light emission data of the first subfield SF1 corresponding to the pixels P-5 and P-6 are changed to the light emission datum of the first subfield SF1 corresponding to the pixel P-4, and the light emission datum of the second subfield SF2 corresponding to the pixel P-5 is changed to the light emission datum of the second subfield SF2 corresponding to the pixel P-4, but the light emission data of the first to fourth subfields SF1 to SF4 corresponding to the pixel P-4 are not changed.

The present embodiment, as described above, can make the boundary between the first image I3 and the second image I4 clear, and prevent the occurrence of motion blur or dynamic false contours that can be generated when the rearrangement process is performed on a boundary part in which the directions of the motion vectors are discontinuous.

A video display apparatus according to another embodiment of the present invention is described next.

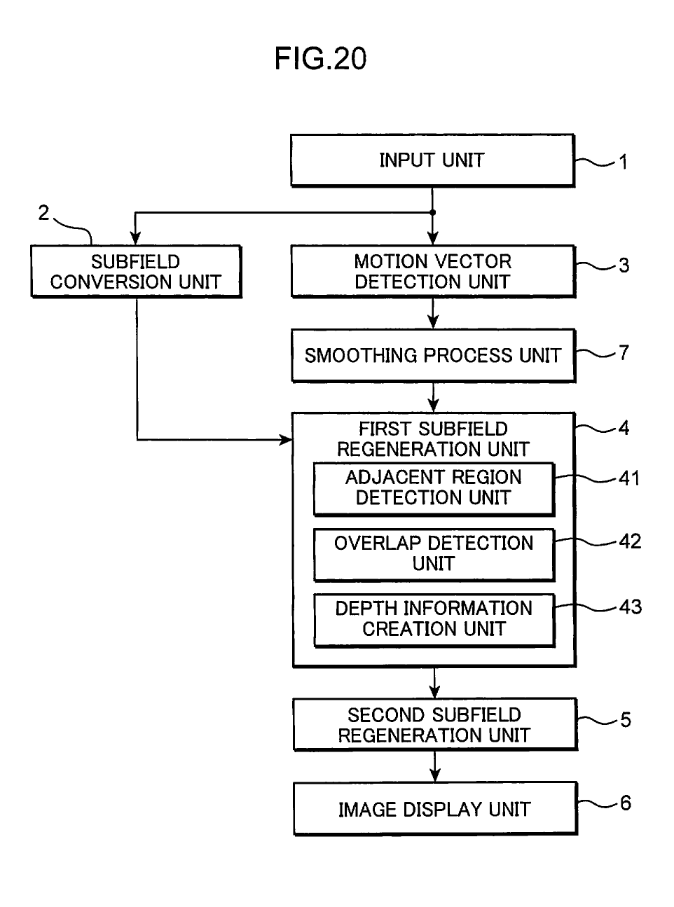

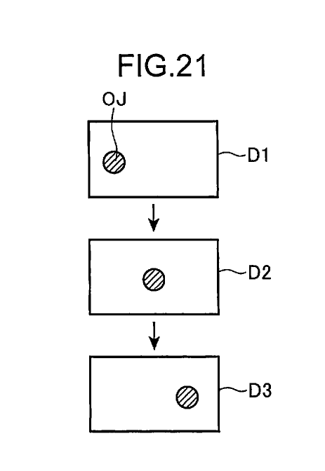

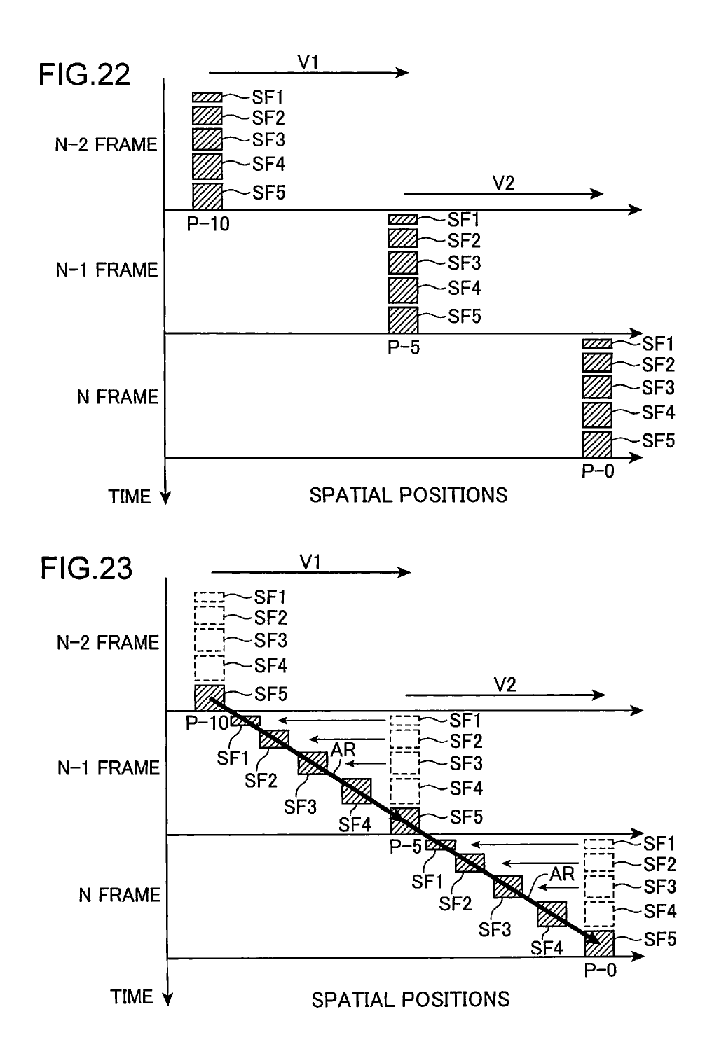

FIG. 20 is a block diagram showing a configuration of a video display apparatus according to another embodiment of the present invention. The video display apparatus shown in FIG. 20 has the input unit 1, the subfield conversion unit 2, the motion vector detection unit 3, the first subfield regeneration unit 4, the second subfield regeneration unit 5, the image display unit 6, and a smoothing process unit 7. The subfield conversion unit 2, motion vector detection unit 3, first subfield regeneration unit 4, second subfield regeneration unit 5, and smoothing process unit 7 constitute a video processing apparatus that processes an input image so as to divide one field or one frame into a plurality of subfields and combine an emission subfield in which light is emitted and a non-emission subfield in which light is not emitted in order to perform gradation display.

Note that the same configurations as those of the video display apparatus shown in FIG. 1 are assigned the same reference numerals in the video display apparatus shown in FIG. 20, to omit the description thereof.

The smoothing process unit 7, constituted by, for example, a low-pass filter, smoothes the values of the motion vectors detected by the motion vector detection unit 3 in the boundary part between the foreground image and the background image. For example, when rearranging the display screen in which the values of the motion vectors of continuous pixels change in such a manner as “666666000000” along a direction of movement, the smoothing process unit 7 smoothes these values of the motion vectors into “654321000000.”

In this manner, the smoothing process unit 7 smoothes the values of the motion vectors of the background image into continuous values in the boundary between the static foreground image and the moving background image. The first subfield regeneration unit 4 then spatially rearranges the light emission data of the subfields, which are converted by the subfield conversion unit 2, with respect to the respective pixels of the frame N, in accordance with the motion vectors smoothed by the smoothing process unit 7. Accordingly, the first subfield regeneration unit 4 generates the rearranged light emission data of the subfields for the respective pixels of the frame N.

As a result, the static foreground image and the moving background image become continuous and are displayed naturally in the boundary therebetween, whereby the subfields can be rearranged with a high degree of accuracy.

It should be noted that the specific embodiments described above mainly include the inventions having the following configurations.

A video processing apparatus according to one aspect of the present invention is a video processing apparatus, which processes an input image so as to divide one field or one frame into a plurality of subfields and combine an emission subfield in which light is emitted and a non-emission subfield in which light is not emitted in order to perform gradation display, the video processing apparatus having: a subfield conversion unit for converting the input image into light emission data for each of the subfields; a motion vector detection unit for detecting a motion vector using at least two or more input images that are temporally adjacent to each other; a first regeneration unit for collecting the light emission data of the subfields of pixels that are located spatially forward by the number of pixels corresponding to the motion vector detected by the motion vector detection unit, and thereby spatially rearranging the light emission data for each of the subfields that are converted by the subfield conversion unit, so as to generate rearranged light emission data for each of the subfields; and a detection unit for detecting an adjacent region between a first image and a second image contacting with the first image in the input image, wherein the first regeneration unit does not collect the light emission data outside the adjacent region detected by the boundary detection unit.

According to this video processing apparatus, the input image is converted into the light emission data for each of the subfields, and the motion vector is detected using at least two or more input images that are temporally adjacent to each other. The light emission data for each of the subfields are spatially rearranged by collecting the light emission data of the subfields of the pixels that are located spatially forward by the number of pixels corresponding to the motion vector, whereby the rearranged light emission data for each of the subfields are generated. In so doing, the adjacent region between the first image and the second image contacting with the first image in the input image is detected, and the light emission data are not collected outside this detected adjacent region.

Therefore, when collecting the light emission data of the subfields of the pixels that are located spatially forward by the number of pixels corresponding to the motion vector, the light emission data are not collected outside the adjacent region between the first image and the second image contacting with the first image in the input image. Therefore, motion blur or dynamic false contours that can occur in the vicinity of the boundary between the foreground image and the background image can be prevented reliably.

A video processing apparatus according to another aspect of the present invention is a video processing apparatus, which processes an input image so as to divide one field or one frame into a plurality of subfields and combine an emission subfield in which light is emitted and a non-emission subfield in which light is not emitted in order to perform gradation display, the video processing apparatus having: a subfield conversion unit for converting the input image into light emission data for each of the subfields; a motion vector detection unit for detecting a motion vector using at least two or more input images that are temporally adjacent to each other; a first regeneration unit for collecting the light emission data of the subfields of pixels that are located spatially forward by the number of pixels corresponding to the motion vector detected by the motion vector detection unit, and thereby spatially rearranging the light emission data for each of the subfields that are converted by the subfield conversion unit, so as to generate rearranged light emission data for each of the subfields; and a detection unit for detecting an adjacent region between a first image and a second image contacting with the first image in the input image, wherein the first regeneration unit collects the light emission data of the subfields that exist on a plurality of straight lines.

According to this video processing apparatus, the input image is converted into the light emission data for each of the subfields, and the motion vector is detected using at least two or more input images that are temporally adjacent to each other. The light emission data of the subfields are spatially rearranged by collecting the light emission data for each of the subfields of the pixels that are located spatially forward by the number of pixels corresponding to the motion vector, whereby the rearranged light emission data for each of the subfields are generated. In so doing, the adjacent region between the first image and the second image contacting with the first image in the input image is detected, and the light emission data of the subfields on the plurality of straight lines are collected.

Therefore, when collecting the light emission data of the subfields of the pixels that are located spatially forward by the number of pixels corresponding to the motion vector, the light emission data of the subfields on the plurality of straight lines are collected. Therefore, motion blur or dynamic false contours that can occur in the vicinity of the boundary between the foreground image and the background image can be prevented reliably.

A video processing apparatus according to yet another aspect of the present invention is a video processing apparatus, which processes an input image so as to divide one field or one frame into a plurality of subfields and combine an emission subfield in which light is emitted and a non-emission subfield in which light is not emitted in order to perform gradation display, the video processing apparatus having: a subfield conversion unit for converting the input image into light emission data for each of the subfields; a motion vector detection unit for detecting a motion vector using at least two or more input images that are temporally adjacent to each other; a first regeneration unit for spatially rearranging the light emission data for each of the subfields that are converted by the subfield conversion unit, with respect to the subfields of pixels located spatially forward, in accordance with the motion vector detected by the motion vector detection unit, so as to generate rearranged light emission data for each of the subfields; and a detection unit for detecting an adjacent region between a first image and a second image contacting with the first image in the input image, wherein the light emission data of the subfields of the pixels that are located spatially forward are arranged in at least one region between a region to which the rearranged light emission data generated by the first regeneration unit are output and the adjacent region detected by the detection unit.

According to this video processing apparatus, the input image is converted into the light emission data for each of the subfields, and the motion vector is detected using at least two or more input images that are temporally adjacent to each other. The light emission data for each of the subfields are spatially rearranged with respect to the subfields of the pixels located spatially forward, in accordance with the motion vector, whereby the rearranged light emission data for each of the subfields are generated. In so doing, the adjacent region between the first image and the second image contacting with the first image in the input image is detected, and the light emission data of the subfields of the pixels that are located spatially forward are arranged in at least some regions between the region to which the generated rearranged light emission data are output and the detected adjacent region.

Because the light emission data of the subfields of the pixels that are located spatially forward are arranged in at least some regions between the region to which the generated rearranged light emission data are output and the adjacent region between the first image and the second image contacting with the first image in the input image, motion blur or dynamic false contours that can occur in the vicinity of the boundary between the foreground image and the background image can be prevented reliably.

Moreover, in the video processing apparatus described above, it is preferred that the first regeneration unit collect the light emission data of the subfields of the pixels corresponding to the adjacent region, with respect to the subfields, the light emission datum is not collected.

According to this configuration, because the light emission data of the subfields of the pixels corresponding to the adjacent region are collected with respect to the subfields, the light emission datum is not collected, the boundary between the foreground image and the background image can be made clear, and motion blur or dynamic false contours that can occur in the vicinity of the boundary can be prevented reliably.

In addition, in the video processing apparatus described above, it is preferred that the first image include a foreground image showing a foreground, that the second image include a background image showing a background, that the video processing apparatus further include a depth information creation unit for creating depth information for each of pixels where the foreground image and the background image overlap on each other, the depth information indicating whether each of the pixels corresponds to the foreground image or the background image, and that the first regeneration unit collect the light emission data of the subfields of pixels that constitute the foreground image specified by the depth information created by the depth information creation unit.

According to this configuration, the depth information is created for each of the pixels where the foreground image and the background image overlap on each other, so as to indicate whether each of the pixels corresponds to the foreground image or the background image. Then, the light emission data of the subfields of the pixels that constitute the foreground image specified based on the depth information are collected.

Therefore, when the foreground image and the background image overlap on each other, the light emission data of the subfields of the pixels constituting the foreground image are collected. As a result, motion blur or dynamic false contours that can occur in the overlapping part between the foreground image and the background image can be prevented reliably.

Furthermore, in the video processing apparatus described above, it is preferred that the first image include a foreground image showing a foreground, that the second image include a background image showing a background, and that the video processing apparatus further include a depth information creation unit for creating depth information for each of pixels where the foreground image and the background image overlap on each other, the depth information indicating whether each of the pixels corresponds to the foreground image or the background image, and a second regeneration unit for changing the light emission data of the subfields corresponding to pixels that have been moved spatially rearward by the number of pixels corresponding to the motion vector detected by the motion vector detection unit, to the light emission data of the subfields of the pixels obtained prior to the movement, with respect to the pixels that constitute the foreground image specified by the depth information created by the depth information creation unit, and thereby spatially rearranging the light emission data for each of the subfields that are converted by the subfield conversion unit, so as to generate the rearranged light emission data for each of the subfields.

According to this configuration, the depth information is created for each of the pixels where the foreground image and the background image overlap on each other, so as to indicate whether each of the pixels corresponds to the foreground image or the background image. Then, with respect to the pixels that constitute the foreground image specified based on the depth information, the light emission data of the subfields corresponding to the pixels that are moved spatially rearward by the number of pixels corresponding to the motion vector, to the light emission data of the subfields of the pixels obtained prior to the movement. Consequently, the light emission data for each of the subfields are spatially rearranged, and the rearranged light emission data for each of the subfields are generated.

Therefore, in the pixels that constitute the foreground when the foreground image and the background image overlap on each other, the light emission data of the subfields corresponding to the pixels that are moved spatially rearward by the number of pixels corresponding to the motion vector are changed to the light emission data of the subfields of the pixels obtained prior to the movement. This allows the line of sight of the viewer to move smoothly as the foreground image moves, preventing the occurrence of motion blur or dynamic false contours that can be generated in the overlapping part between the foreground image and the background image.

It is also preferred in the video processing apparatus described above, that the foreground image be a character. According to this configuration, for the pixels that constitute the character when the character overlaps with the background image, the light emission data of the subfields corresponding to the pixels that are moved spatially rearward by the number of pixels corresponding to the motion vector are changed to the light emission data of the subfields of the pixels obtained prior to the movement. This allows the line of sight of the viewer to move smoothly as the character moves, preventing the occurrence of motion blur or dynamic false contours that can be generated in the overlapping part between the foreground image and the background image.

In the video processing apparatus described above, for the pixels that constitute the foreground image moving horizontally in the input image, the second regeneration unit preferably changes the light emission data of the subfields corresponding to the pixels that have been moved spatially rearward by the number of pixels corresponding to the motion vector detected by the motion vector detection unit, to the light emission data of the subfields of the pixels obtained prior to the movement.

According to this configuration, only with regard to the pixels that configure the foreground image moving horizontally in the input image, the light emission data of the subfields corresponding to the pixels that are moved spatially rearward by the number of pixels corresponding to the motion vector, are changed to the light emission data of the subfields of the pixels obtained prior to the movement. As a result, the number of vertical line memories can be reduced, and the memories used can be reduced by the second regeneration unit.

In the video processing apparatus described above, it is preferred that the depth information creation unit create the depth information based on the sizes of motion vectors of at least two or more frames. According to this configuration, the depth information can be created based on the sizes of the motion vectors of at least two or more frames.

A video display apparatus according to another aspect of the present invention has any of the video processing apparatuses described above, and a display unit for displaying an image by using corrected rearranged light emission data that are output from the video processing apparatus.

In this video display apparatus, when collecting the light emission data of the subfields corresponding to the pixels that are located spatially forward by the number of pixels corresponding to the motion vector, the light emission data are not collected outside the adjacent region between the first image and the second image contacting with the first image in the input image. Therefore, motion blur or dynamic false contours that can occur in the vicinity of the boundary between the foreground image and the background image can be prevented reliably.

Note that the specific embodiments or examples that are provided in the paragraphs describing the best mode for carrying out the invention are merely to clarify the technical contents of the present invention, and therefore should not be narrowly interpreted. The present invention is capable of various changes without departing from the spirit of the present invention and the scope of the claims.

### INDUSTRIAL APPLICABILITY

The video processing apparatus according to the present invention is capable of reliably preventing the occurrence of motion blur or dynamic false contours, and is therefore useful as a video processing apparatus that processes an input image so as to divide one field or one frame into a plurality of subfields and combine an emission subfield in which light is emitted and a non-emission subfield in which light is not emitted in order to perform gradation display.

1. A video processing apparatus, which processes an input image so as to divide one field or one frame into a plurality of subfields and combine an emission subfield in which light is emitted and a non-emission subfield in which light is not emitted in order to perform gradation display,
the video processing apparatus comprising:
a subfield conversion unit for converting the input image into light emission data for each of the subfields;
a motion vector detection unit for detecting a motion vector using at least two or more input images that are temporally adjacent to each other;
a first regeneration unit for collecting the light emission data of the subfields of pixels that are located spatially forward by the number of pixels corresponding to the motion vector detected by the motion vector detection unit, and thereby spatially rearranging the light emission data for each of the subfields that are converted by the subfield conversion unit, so as to generate rearranged light emission data for each of the subfields; and
a detection unit for detecting an adjacent region between a first image and a second image contacting with the first image in the input image,
wherein the first regeneration unit does not collect the light emission data outside the adjacent region detected by the detection unit.

2. An video processing apparatus, which processes an input image so as to divide one field or one frame into a plurality of subfields and combine an emission subfield in which light is emitted and a non-emission subfield in which light is not emitted in order to perform gradation display,
the video processing apparatus comprising:
a subfield conversion unit for converting the input image into light emission data for each of the subfields;
a motion vector detection unit for detecting a motion vector using at least two or more input images that are temporally adjacent to each other;
a first regeneration unit for collecting the light emission data of the subfields of pixels that are located spatially forward by the number of pixels corresponding to the motion vector detected by the motion vector detection unit, and thereby spatially rearranging the light emission data for each of the subfields that are converted by the subfield conversion unit, so as to generate rearranged light emission data for each of the subfields; and
a detection unit for detecting an adjacent region between a first image and a second image contacting with the first image in the input image,
wherein the first regeneration unit collects the light emission data of the subfields that exist on a plurality of straight lines.

3. An video processing apparatus, which processes an input image so as to divide one field or one frame into a plurality of subfields and combine an emission subfield in which light is emitted and a non-emission subfield in which light is not emitted in order to perform gradation display,
the video processing apparatus comprising:
a subfield conversion unit for converting the input image into light emission data for each of the subfields;
a motion vector detection unit for detecting a motion vector using at least two or more input images that are temporally adjacent to each other;
a first regeneration unit for spatially rearranging the light emission data for each of the subfields that are converted by the subfield conversion unit, with respect to the subfields of pixels located spatially forward, in accordance with the motion vector detected by the motion vector detection unit, so as to generate rearranged light emission data for each of the subfields; and
a detection unit for detecting an adjacent region between a first image and a second image contacting with the first image in the input image,
wherein the light emission data of the subfields of the pixels that are located spatially forward are arranged in at least one region between a region to which the rearranged light emission data generated by the first regeneration unit are output and the adjacent region detected by the detection unit.

4. The video processing apparatus according to claim 1, wherein the first regeneration unit collects the light emission data of the subfields of the pixels constituting the adjacent region, with respect to the subfields, the light emission data of which are not collected.

5. The video processing apparatus according to claim 1, wherein
the first image includes a foreground image showing a foreground,
the second image includes a background image showing a background,
the video processing apparatus further comprises a depth information creation unit for creating depth information for each of pixels where the foreground image and the background image overlap on each other, the depth information indicating whether each of the pixels corresponds to the foreground image or the background image, and
the first regeneration unit collects the light emission data of the subfields of pixels that constitute the foreground image specified by the depth information created by the depth information creation unit.

6. The video processing apparatus according to claim 1, wherein
the first image includes a foreground image showing a foreground,
the second image includes a background image showing a background, and
the video processing apparatus further comprises:
a depth information creation unit for creating depth information for each of pixels where the foreground image and the background image overlap on each other, the depth information indicating whether each of the pixels corresponds to the foreground image or the background image; and
a second regeneration unit for changing the light emission data of the subfields corresponding to pixels that are moved spatially rearward by the number of pixels corresponding to the motion vector detected by the motion vector detection unit, to the light emission data of the subfields of the pixels obtained prior to the movement, with respect to the pixels that constitute the foreground image specified by the depth information created by the depth information creation unit, and thereby spatially rearranging the light emission data for each of the subfields that are converted by the subfield conversion unit, so as to generate the rearranged light emission data for each of the subfields.

7. The video processing apparatus according to claim 6, wherein the foreground image is a character.

8. The video processing apparatus according to claim 6, wherein the second regeneration unit changes the light emission data of the subfields of pixels that have been moved spatially rearward by the number of pixels corresponding to the motion vector detected by the motion vector detection unit, with respect to the pixels constituting the foreground image moving horizontally in the input image, to the light emission data of the subfields of the pixels obtained prior to the movement.

9. The video processing apparatus according to claim 5, wherein the depth information creation unit creates the depth information based on sizes of motion vectors of at least two or more frames.

10. A video display apparatus, comprising:
the video processing apparatus according to claim 1; and
a display unit for displaying an image by using corrected rearranged light emission data that are output from the video processing apparatus.
